(19) United States
(12) Patent Application Publication
(10) Pub. No.: US 2025/0205096 A1
(43) Pub. Date: Jun. 26, 2025

(54) TRANSFER DEVICE AND CONTROL SYSTEM

(71) Applicant: Able Innovations Inc., Toronto (CA)

(72) Inventors: Philip Chang, Toronto (CA); Jian Huang, Toronto (CA); Gurdarshan Tiwana, Toronto (CA); Ayeda Sayeed, Toronto (CA); Nara Levi, Toronto (CA)

(21) Appl. No.: 18/849,991

(22) PCT Filed: Mar. 30, 2023
(86) PCT No.: PCT/CA2023/050432

§ 371 Date: Sep. 23, 2024

Related U.S. Application Data
(60) Provisional application No. 63/362,301, filed on Mar. 31, 2022.

(51) Int. Cl. A61G 7/10

(52) U.S. Cl. CPC A61G 7/1032; A61G 7/1046; A61G 7/1065; A61G 7/1067; A61G 2200/32

(57) ABSTRACT

A transfer device, such as a patient transfer device, includes a device body, a transfer platform supported by the device body, a plurality of subsystems, a plurality of subsystem controllers, each configured to control operation of one of the plurality of subsystems, and a system processor in communication with the plurality of subsystem controllers. The transfer platform has at least one conveyor belt configured to move an object. Each subsystem is configured to implement a function of the transfer device. The system processor is configured to monitor and communicate with the plurality of subsystem controllers, receive operator inputs from a transfer device operator, make decisions about a transfer operation based on inputs received from a transfer device operator and/or inputs received from the plurality of subsystem controllers, and send commands to the plurality of subsystem controllers to accomplish various transfer operation routines.

### CROSS-REFERENCE TO RELATED APPLICATION(S)

This application claims the benefit under 35 U.S.C. § 119 (e) to U.S. Provisional Application No. 63/362,301, filed Mar. 31, 2022, and entitled “Distributed Control System for a Transfer Device,” which is hereby incorporated by reference in its entirety.

### TECHNICAL FIELD

This disclosure relates generally to transfer devices for moving an object, and more particularly to control systems and methods for such transfer devices.

### BACKGROUND

A transfer device generally has a device body and a transfer platform configured to move an object. A transfer device can be controlled by a control system, for example to control movement of the transfer platform when moving an object or patient.

According to conventional approaches, a control system used for a transfer device may have several shortcomings. For instance, the control system (i) may be expensive, (ii) may involve various design compromises, (iii) may lack modularity, scalability and adaptability, and (iv) may suffer from poor signal management and integrity.

Moreover, the control system may have limited automation and control capabilities, thereby relying on manual user control and intervention. Unfortunately, this manual user control and intervention can be cumbersome and can result in difficulties such as variations in user interaction and interpretation. Under the circumstances where the object is fragile, or delicate, especially in the case of transferring patients whom may be infirm and/or immobile, incorrect inputs and control commands from a user may result in serious harm or damage to the patient or object being transferred.

Therefore, conventional approaches leave much to be desired. An objective of the disclosed technology is to improve upon the conventional approaches to address or mitigate some or all of the shortcomings noted above.

### SUMMARY

The disclosed technology provides transfer devices and related control systems, devices and methods for moving an object. One aspect of the disclosed technology includes a transfer device with a control system. In various implementations the transfer device is configured to move patients and thus in some cases may be referred to as a patient transfer device. The transfer device according to various implementations can have variations in architecture, but generally includes a body with actuators, a transfer platform and a conveyor belt or multiple conveyor belts operably configured to move an object such as a patient. In some cases various components and/or functions of the transfer device may be considered as being part of one or more operational subsystems of the transfer device.

The control system has a system processor which maintains oversight of multiple subsystem controllers in communication with the system processor. In some cases the control system is referred to as a distributed control system since control of the transfer device is distributed among a system processor and multiple subsystem controllers. Each subsystem controller is configured to communicate with and/or control various components to implement one or more functions of the transfer device. In some cases a subsystem controller can be considered to be part of and/or in control of one of the operational subsystems of the transfer device.

The system processor is configured to carry out various activities depending on the state and desired operating mode of the transfer device. In some instances the system processor is configured to monitor and communicate with one or more of the subsystem controllers. According to various implementations, the system processor is configured to perform particular operations or actions by virtue of loading and executing instructions stored in one or more memory devices. The system processor carrying out the instructions causes the control system and/or the transfer device to carry out the desired actions.

According to various implementations, the system processor is configured with instructions that include pre-loaded, adaptable and interactive subroutines and algorithms. In some instances the instructions configure the system processor to take actions based on the information collected or transmitted from the subsystem controllers. For brevity and convenience, the system processor is at times described as carrying out various actions. Such references imply that the system processor is configured with appropriate instructions for execution by the system processor. In addition, the term “manager system” is used at times herein to refer to the system processor and various instructions stored in memory and/or the system processor operating according to various instructions (e.g., a collection of software applications running on the system processor) and thus being configured to carry out corresponding activities.

Compared to using a single microcontroller, utilizing multiple subsystem controllers may result in reduced cost, avoidance of design compromises, and increased modularity, which in turn could enable scalability and adaptability. Also, in various implementations one or more of the subsystem controllers can be located in different regions of the transfer device (e.g. not all in a single location), thus providing a physically distributed control system. Such placement can allow various subsystem controllers to be in the vicinity of particular sensors and/or actuators, so as to enable signals to be sent and received over shorter distances, which could improve signal integrity and mitigate noise.

Various implementations of the distributed control system disclosed herein enable automatic and semi-autonomous operation. In such cases, various subsystem controllers can work together to perform patient transfers automatically without user intervention. The distributed control system can include various subsystem controllers depending upon the implementation. In various cases the distributed control system has a system processor configured with instructions to implement an abstracted operating system and transfer program which serves the purpose of collecting, interpreting and sending commands on behalf of a human operator (also referred to herein as a “user”). In such cases the manager system (i.e. the system processor programmed with particular instructions) can be configured to autonomously make decisions and send commands based on information received from the operator as well as from one or more subsystem controllers. Subsystem controllers may include, but are not limited to, a power systems controller, a transfer operations controller (e.g. that at least operates the platform and conveyor belts), and a lift and tilt actuator controller. It will be appreciated that additional proximity sensors and/or peripheral devices may also be included in a typical configuration of such a transfer device and control system.

Various implementations of the disclosed technology include a transfer device and/or distributed control system with one or more of the following aspects and/or features. In some implementations a manager system is configured to perform various operations based on the operator's input of transfer parameters (e.g. object or patient characteristics such as, for example, height and body mass index). Other inputs might include parameters for the support surface (e.g. bed), such as the width and type of mattress (e.g. air or foam mattress). In various cases the manager system may carry out routines to enable collaborative operation of multiple subsystem controllers such as, for example, coordination and unification of operating states. In some cases the manager system may perform protective and safety routines to identify and communicate device-wide errors or faults to needed subsystem controllers, thereby allowing the subsystem controllers to take corresponding actions such as, e.g., stopping motors. In some cases the manager system may centralize various device-level subroutines. As an example, the manager system may perform security for the transfer device including preventing unauthorized access and/or inappropriate commands from being sent directly to subsystem controllers in the event of a security breach (e.g. hacking event).

Also disclosed is a method of operating a transfer device. In various implementations the transfer device has a device body, a transfer platform, at least one conveyor belt, a distributed control system including a manager system and multiple subsystem controllers. The manager system includes a system processor and executable instructions stored in a physical, non-transitory medium that cause the system processor to relay information to the subsystem controllers, record and transmit the information obtained, and send actions and/or requests to the subsystem controllers in the distributed control system.

According to various aspects, another method of operating a transfer device includes receiving one or more images from at least one imaging device, and processing the image(s) to determine at least one variable that relates to the transfer of an object by the transfer device.

Also disclosed is a non-transitory computer readable medium having recorded thereon statements and instructions that, when executed by a system processor of a transfer device, configure the system processor to implement one or more of the various systems and methods disclosed herein.

Examples of various implementations the disclosed technology include, but are not limited to, the following:

In Example 1, a transfer device comprising: a device body, a transfer platform supported by the device body, the transfer platform comprising at least one conveyor belt configured to move an object onto and/or off of the transfer platform, a plurality of subsystems, each subsystem configured to implement a function of the transfer device, a plurality of subsystem controllers, each subsystem controller configured to control operation of one of the plurality of subsystems, and a system processor in communication with the plurality of subsystem controllers, the system processor configured to: monitor and communicate with the plurality of subsystem controllers, receive operator inputs from a transfer device operator, make decisions about a transfer operation based on inputs received from a transfer device operator and inputs received from the plurality of subsystem controllers, and send commands to the plurality of subsystem controllers.

In Example 2, the transfer device of Example 1, wherein the two or more of the plurality of subsystem controllers are located in different regions of the transfer device near to one or more sensors and/or actuators.

In Example 3, the transfer device of Example 1 or Example 2, wherein the system processor and the plurality of subsystem controllers are configured to operate together to perform patient transfers automatically without user intervention.

In Example 4, the transfer device of any one of Examples 1 to 3, wherein the system processor is configured to control a Human-Machine Interface (HMI) of the transfer device.

In Example 5, the transfer device of any one of Examples 1 to 4, wherein the plurality of subsystem controllers comprise a subsystem controller configured to control transfers of an object.

In Example 6, the transfer device of Example 5, wherein the distributed control system is configured to receive a tension and displacement of at least one conveyor belt along with a location and speed of the transfer platform for use in methods to transfer a patient.

In Example 7, the transfer device of any one of Examples 1 to 6, wherein the plurality of subsystem controllers comprises a subsystem controller configured to adjust height and angles of the transfer platform, and/or transportation of the transfer device.

In Example 8, the transfer device of any one of Examples 1 to 7, wherein the plurality of subsystem controllers comprises a subsystem controller configured to control one or more peripheral subsystems of the transfer device not involved in movement of the transfer platform.

In Example 9, the transfer device of any one of Examples 1 to 8, wherein the plurality of subsystem controllers comprises a subsystem controller configured to control power delivery to electronic components of the distributed control system and to actuators of the transfer device.

In Example 10, the transfer device of any one of Examples 1 to 9, wherein the plurality of subsystems are configured to implement one or more of (i) transferring an object, (ii) adjusting height and angles of the transfer platform, and/or transporting the transfer device, (iii) controlling peripherals of the transfer device not involved in movement of the transfer platform, (iv) providing device security, and (v) controlling power delivery to electronic components of the distributed control system and to actuators of the transfer device.

In Example 11, the transfer device of any one of Examples 1 to 10, wherein the system processor is configured to establish a secure connection to an external network to upload captured images, diagnostics data and/or download firmware changes.

In Example 12, the transfer device of Example 11, wherein the external network is an intranet configured to aid communication of multiple transfer devices to each other.

In Example 13, the transfer device of Example 11, wherein the external network is the world wide web.

In Example 14, the transfer device of any one of Examples 1 to 13, wherein the system processor is in communication with an imaging subsystem comprising at least one imaging device and wherein the system processor is configured to receive at least one captured image from the at least one imaging device, and determine at least one variable using image processing of the captured image, such that the at least one variable relates to transfer of an object by the transfer device.

In Example 15, the transfer device of Example 14, wherein the system processor is configured to receive a plurality of a captured images forming a video feed from the at least one imaging device, and determine at least one variable using image processing of the video feed, such that the at least one variable relates to transfer of an object by the transfer device.

In Example 16, the transfer device of any one of Examples 14 or Example 15, wherein the subsystem controllers are configured to determine at least one variable using processing of the at least one captured image, such that the at least one variable relates to transfer of an object by the transfer device.

In Example 17, the transfer device of Example 16, wherein the at least one variable comprises a mass and/or a volume of the object.

In Example 18, the transfer device of Example 16 or Example 17, wherein the at least one variable comprises a position and/or an orientation of the object.

In Example 19, the transfer device of any one of Examples 16 to 18, wherein the system processor is configured to assess a risk of damage to the object based on the at least one variable.

In Example 20, the transfer device of any one of Examples 16 to 19, wherein the system processor is configured to determine parameters and/or limits for the transfer device to transfer the object based on the at least one variable.

In Example 21, the transfer device of Example 20, wherein the system processor receives feedback from at least one of the subsystem controllers regarding measured forces during transfer of the object, and the system processor is configured to adjust the parameters and/or limits in accordance with the feedback.

In Example 22, the transfer device of any one of Examples 16 to 21, wherein the system processor is connected to persistent memory configured to record the video or image feed for future playback.

In Example 23, the transfer device of any one of Examples 16 to 21, wherein the system processor is configured to establish an external data connection and is configured to send the image or video feed over the external data connection to an external receiving unit for monitoring and observation.

In Example 24, a method for execution by a system processor of a transfer device, the transfer device comprising a device body and a transfer platform configured to move an object, the method comprising: receiving at least one image from at least one imaging device, determining at least one variable using image processing of the at least one image, such that the at least one variable relates to transfer of an object by the transfer device.

In Example 25, the method of Example 24, wherein the at least one variable comprises a mass and/or a volume of the object.

In Example 26, the method of Example 24 or Example 25, wherein the at least one variable comprises a position and/or an orientation of the object.

In Example 27, the method of any one of Examples 24 to 26, further comprising: assessing a risk of damage to the object based on the at least one variable that has been determined.

In Example 28, the method of any one of Examples 24 to 27, further comprising: determining parameters and/or limits for the transfer device to transfer the object based on the at least one variable that has been determined.

In Example 29, the method of Example 28, further comprising: receiving feedback regarding measured forces during transfer of the object, and adjusting the parameters and/or limits in accordance with the feedback.

In Example 30, the method of any one of Examples 24 to 29, further comprising: recording the at least one image for future playback.

In Example 31, the method of any one of Examples 24 to 30, further comprising: establishing an external data connection, and sending the at least one image over the external data connection to an external receiving unit for monitoring and observation.

In Example 32, a non-transitory computer readable medium having recorded thereon statements and instructions that, when executed by a system processor of a transfer device, configure the system processor to implement the method of any one of Examples 24 to 31.

In Example 33, an apparatus comprising a component or any combination of components as described and/or depicted herein.

In Example 34, a method comprising a step or any combination of steps as described and/or depicted herein.

In Example 35, a non-transitory computer readable medium having recorded thereon statements and instructions that, when executed by a processor of an apparatus, configure the processor to implement a method comprising a step or any combination of steps as described and/or depicted herein.

Other aspects and features of the disclosed technology will become apparent to those ordinarily skilled in the art upon review of the following description of the various embodiments of the disclosure.

### BRIEF DESCRIPTION OF THE DRAWINGS

Embodiments will now be described with reference to the attached drawings in which:

FIG. 1 is a block diagram of a distributed control system for a transfer device according to various implementations;

FIGS. 2A-2C are schematic diagrams of example transfer devices according to various implementations;

FIGS. 3A-3B are block diagrams of distributed control systems for a transfer device according to various implementations;

FIGS. 4A-4I are various views of example user interface controls for a Human-Machine Interface (HMI) of a transfer device according to various implementations;

FIG. 5A is a flow diagram of a method for transferring an object with a transfer device according to various implementations;

FIG. 5B is a flow diagram of a method for transferring an object with a transfer device including image processing according to various implementations;

FIG. 5C is a flow diagram of an image analysis method according to various implementations;

FIG. 5D is a flow diagram of a method for estimating mass and volume of a patient according to various implementations;

FIG. 5E is a flow diagram of a method for making a image-based transfer risk assessment according to various implementations;

FIG. 5F is a flow diagram of a method of relaying identified risks and other information to a user of a transfer device according to various implementations;

FIG. 6 is a perspective view of a transfer device with an imaging system according to various implementations;

FIG. 7 is a block diagram of a distributed control system for a transfer device according to various implementations;

FIG. 8A is a flow diagram of a method for aligning a transfer device according to various implementations;

FIG. 8B is a flow diagram of a method for detecting contact between a device transfer platform and a support surface according to various implementations;

FIG. 8C is a flow diagram of a method for determining characteristics of a support surface according to various implementations;

FIG. 8D is a flow diagram of a method for detecting an obstruction according to various implementations; and

FIG. 8E is a flow diagram of a method for adjusting the position of an object on a transfer device according to various implementations.

FIG. 8F is a series of diagrams that show different scenarios for adjusting the position of an object on a transfer device according to various implementations.

### DETAILED DESCRIPTION

It should be understood at the outset that although illustrative implementations of one or more embodiments of the present disclosure are provided below, the disclosed technology may be implemented using any number of techniques, whether currently known or in existence. The disclosure should in no way be limited to the illustrative implementations, drawings, and techniques illustrated herein, including the exemplary designs and implementations illustrated and described herein, but may be modified within the scope of the appended claims along with their full scope of equivalents.

As noted above, an aspect of the disclosed technology provides transfer devices, systems and methods for moving an object such as, for example, a patient. As used herein and described with respect to the drawings, this aspect of the disclosure is often referred to as a transfer device 200, a patient transfer device 200, and variations thereof. Another aspect of the disclosed technology provides devices, systems and methods for controlling a transfer device 200. As used herein and described with respect to the drawings, this aspect of the disclosure is often referred to as a control system 100, a distributed control system 100, and variations thereof. It should be understood that the use of such terms to refer to these aspects of the disclosure is for brevity and convenience, and is in no way intended to be limiting to any specific modality.

According to various implementations, the architecture of a transfer device can vary, but generally includes a body along with actuators, a transfer platform and a conveyor belt or multiple conveyor belts operably configured to move an object. In various implementations the control system of the transfer device includes a system processor in communication with multiple subsystem controllers. Each subsystem controller is configured to communicate with and/or control various components to implement one or more functions of the transfer device. In some cases, the components and functions of the transfer device can be considered as belonging to one or more operational subsystems of the transfer device. In such cases one or more subsystem controllers can be considered to be part of and/or in control of one of the operational subsystems.

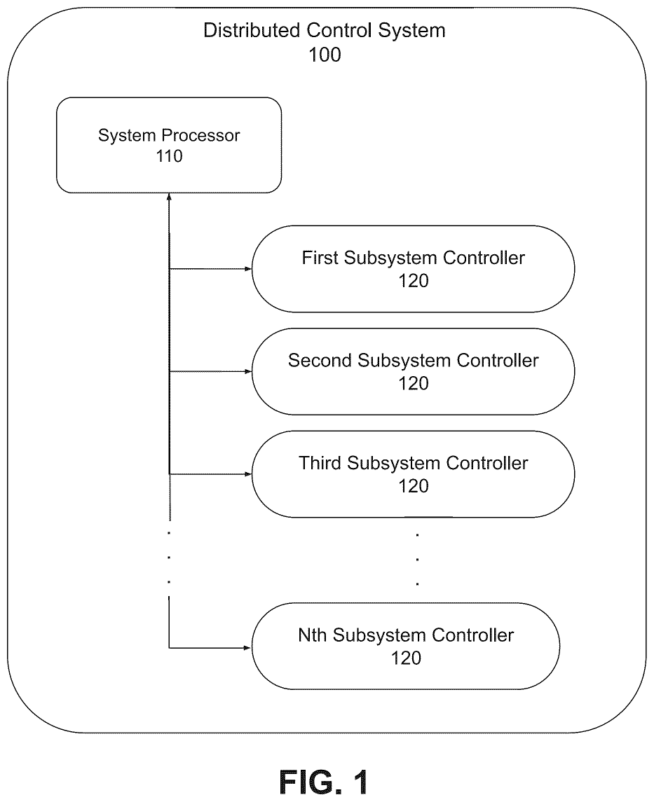

Referring first to FIG. 1, shown is a block diagram of a distributed control system 100 for use with a transfer device 200 according to various implementations of the disclosed technology. The distributed control system 100 has a system processor 110 coupled to multiple subsystem controllers 120, depicted in FIG. 1 as a first through Nth subsystem controller. Each subsystem controller 120 according to these implementations is configured to implement a function of the transfer device 200, such as operation of a transfer sequence, controlling and monitoring power systems, patient monitoring, movement of the transfer device including lifting, tilting and/or transportation, and device security, for example. The system processor 110 is configured to, among other things, monitor and communicate with the subsystem controllers 120.

According to various implementations, the system processor 110 includes or is coupled with one or more physical, non-transitory computer accessible or readable storage devices, which are also referred to herein as “memory” and “memory devices.” The memory may be implemented using any suitable memory technology, which may include, e.g., temporary and more long-term configurations, volatile and non-volatile configurations, and solid state and/or other physical formats. Examples of possible memory include random access memory (RAM), dynamic random-access memory (DRAM), static random-access memory (SRAM), magnetic hard discs, optical discs, floppy discs, flash memory, forms of electrically programmable memory (EPROM) and electrically erasable and programmable (EEPROM) memory, and other forms known in the art.

The memory device(s) coupled with the system processor 110 contain instructions for configuring the system processor 110 to perform particular operations or actions by virtue of loading and executing the instructions. The system processor 110 carrying out the instructions causes the control system 100 and/or the transfer device 200 to carry out the desired actions. References herein to the system processor 110 carrying out various activities imply that the system processor 110 is configured with corresponding instructions for execution. As noted above, the term “manager system” is used herein for convenience to refer to the system processor 110 and various instructions stored in memory and/or the system processor actively operating according to various instructions (e.g. a collection of software applications stored in memory and running on the system processor).

In various implementations, the manager system collects and interprets information from user inputs and the subsystem controllers 120 to perform analyses and calculations and automatically make decisions and subsequently coordinate and command actions for the subsystem controllers 120. In some implementations, the manager system collects information from subsystem controllers 120 and communicates the information to other subsystem controllers 120. In various implementations, the manager system monitors the status and performance of the subsystem controllers 120.

In certain implementations, one or more of the subsystem controllers 120 are located in different regions of the transfer device (e.g. not all in a single location) thus providing a physically distributed control system. Such placement can allow various subsystem controllers to be in the vicinity of various sensors and/or actuators, so as to enable signals to be sent and received over shorter distances, which could improve signal integrity and mitigate noise. As an example, a particular subsystem controller may in some cases be physically located within an area common to multiple components of a particular subsystem of the transfer device. As another example, in some cases a transportation controller which controls the driven and non-driven wheel motors and sensors is located within the base of the transfer device. The location of this controller in the base allows for reduced wiring between the upper and lower assemblies of the transfer device. As another example, in some cases a precision analogue-to-digital conversion system controller is located near load cells which are used to measure the transient forces on the lift actuators of the device. Such a placement is advantageous, as load cells' raw electrical signal is a very small voltage and highly susceptible to noise.

Implementations of the disclosed distributed control system 100 are thus different from a centralized control system in which processing is generally located in one region. As described below, configuring the distributed control system 100 with multiple subsystem controllers 120 in a decentralized manner (e.g. with one, two, or more subsystem controllers 120 located in different parts of the transfer device associated with various functions) can provide several potential benefits over utilizing a centralized control system in one region.

In various cases a first potential benefit of utilizing multiple subsystem controllers 120 is reduced cost. Often processors such as Microcontroller Units (MCUs) are limited in terms of how many General Purpose Input/Outputs (GPIOs) they have. It may be possible for a single MCU to have enough GPIOs to handle all of the functions of the transfer device 200, but that single MCU would likely be expensive. In various implementations each subsystem controller 120 is focused on a function of the transfer device. Thus it is possible to reduce the cost of each subsystem controller 120 by having reduced performance specifications (e.g. such as fewer GPIOs), such that a total cost of all of the subsystem controllers 120 may be less than the cost of a single MCU having enough GPIOs to handle all of the functions.

A second potential benefit of utilizing the subsystem controllers 120 is avoidance of design compromises in various implementations. Trying to use a single MCU could result in various design compromises as a result of a limited number of GPIOs or other specifications. Various customizations or compromises to work around the limited number of GPIOs or other specifications can create difficulties. Meanwhile, in various cases the specifications of the subsystem controllers 120 may be sufficient to avoid any such design compromises. Furthermore, a single MCU architecture, if capable of managing the many sensor and control inputs would likely also have a comparatively higher application cycle execution time than in a distributed control system. For example, implementations of a distributed control system include multiple subsystem controllers 120 working collaboratively, with each subsystem controller 120 having a shorter application cycle execution time than in a single MCU architecture. The subsystem controllers 120 can communicate when and as necessary amongst the distributed control system 100, thereby likely providing an overall improved responsiveness and agility when compared to a system based on a single MCU architecture.

In various implementations a third potential benefit of utilizing the subsystem controllers 120 is modularity, which can in turn enable scalability and adaptability. Since in various implementations each subsystem controller 120 is focused on a function and/or subsystem of the transfer device 200, it is possible to add or remove a function and/or subsystem by adding or removing a subsystem controller associated with that function and/or subsystem. This can enable customization for a transfer device 200, for example to upgrade or defeature one or more functions depending on a customer's request or budget. For example, if a transfer MCU is to be improved, but the human interface is not, only that transfer MCU would be changed. Also note that, revising or redesigning existing controllers can present challenges that are difficult to deal with. In various implementations of the disclosed technology, an additional and/or new function can be added to a transfer device 200 by allowing it to communicate with common components such as the system processor 110. Furthermore, in the case of repair or maintenance of a given function, a subsystem controller 120 associated with the given function can be swapped or replaced without affecting other functions, which may reduce downtime.

A fourth potential benefit of utilizing multiple subsystem controllers 120 is improved signal management and integrity in various cases. There are physical/electrical challenges associated with collection, interpretation and management of sensor signals as well as output of command signals to actuators (e.g. motors, brakes, etc.). In various implementations it becomes possible to have the subsystem controllers 120 distributed in a way that they are located in the vicinity of relevant subsystems, sensors and/or the actuators, so as to enable signals to be sent and received over shorter distances, which can improve signal integrity and mitigate noise. Signal integrity may also be improved by utilizing more specialized processors for specific subsystems, which may not be ideal for the rest of the system. For example, using a processor specialized in analogue to digital conversion (ADC) for sensor interfacing can provide a high fidelity conversion. However, this ADC processor may have limited functional capabilities beyond this task and therefore separation of the conversion from future operations allows these signals to then be transmitted to another processor specialized in digital signal processing and analysis or other operations required to be performed for example.

In some implementations, in addition to the potential benefits noted above, the distributed control system 100 can enhance efficiency and effectiveness of a transfer device 200 by, for example, enabling autonomous and automatic operation of the transfer device while ensuring patient and user safety. In some implementations, the distributed control system 100 reduces the likelihood that in the event of a fault or failure in one part of the transfer device, the distributed control system 100 does not fail, the transfer device is not compromised, and the patient is not endangered.

In the implementation of FIG. 1, the subsystem controllers 120 include a first subsystem controller, a second subsystem controller, and a third subsystem controller. However, more generally, the subsystem controllers 120 can include two or more subsystem controllers, up to N subsystem controllers, as would be readily appreciated. In various cases the number of subsystem controllers 120 depends on how many functions of the transfer device 200 are present according to a particular implementation. In various cases each subsystem controller 120 can be considered to be part of an operational subsystem and/or in control of an operational subsystem of the transfer device 200. Transfer devices 200 of varying kinds may vary in terms of the various subsystems and associated functions present. Also, transfer devices 200 of the same kind can also vary in terms of the various functions provided. For instance, a subsystem or function could be enabled for a first transfer device but disabled for a second transfer device, even though the first and second transfer devices are of the same kind. Thus, the modular nature of the subsystem controllers, functions and subsystems means that they can be selectively enabled or disabled in various cases.

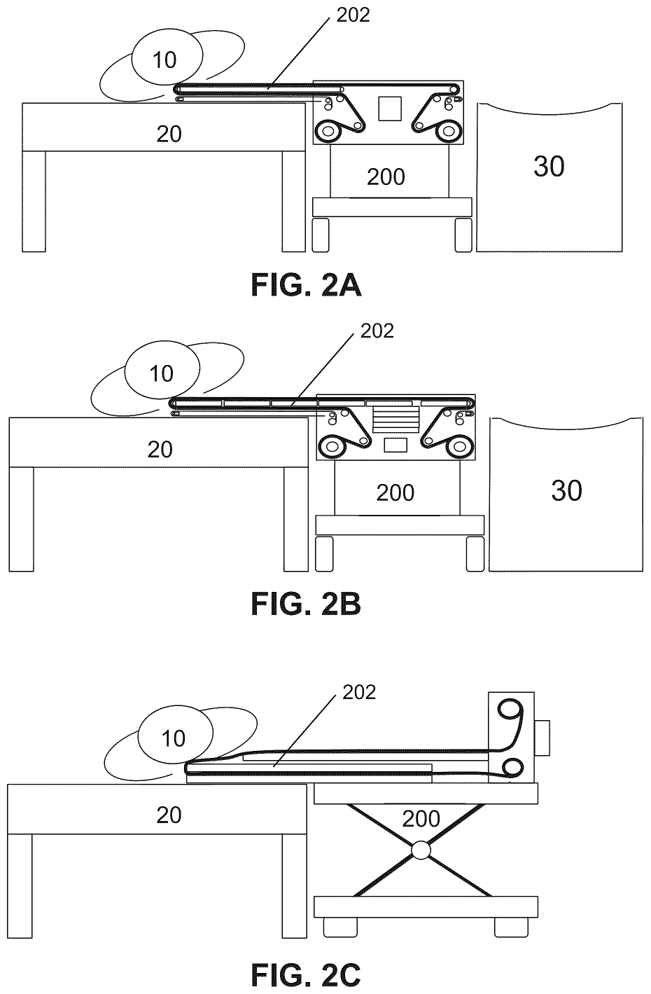

It is to be understood that the distributed control system 100 is applicable to any suitable transfer device 200 having a device body and a transfer platform capable of moving an object or patient. Such movement generally involves a change in physical state of the object or patient. The change in physical state can include a change in location (e.g. moving an object or patient from one location to another location) and/or a change in orientation (e.g. rotating an object or patient by) 90°. Therefore, as used herein, a “patient transfer” performed by a transfer device does not necessarily mean that a patient must change location, particularly when an orientation of the patient is transferred from a first orientation to a second orientation (e.g. rotated from being on the left shoulder on to the stomach). In various implementations the transfer platform can be conveyor-based in that the transfer platform is equipped with a conveyor belt. There are many possibilities. To illustrate this point, reference is made to FIGS. 2A through 2C, which are schematic diagrams of example transfer devices 200 in which the distributed control system 100 could be implemented.

FIG. 2A shows one possible transfer device 200 having a platform plate which is a transfer platform 202 according to various implementations. The platform plate has bidirectional functionality (i.e. capable of moving in both directions) to move a patient 10 from a first location 20 on one side of the transfer device 200 to a second location 30 on the other side of the transfer device 200. The transfer device 200 is conveyor-based in that the platform plate is equipped with a conveyor belt.

FIG. 2B shows another possible transfer device 200 according to various implementations. The transfer device has platform segments instead of a platform plate, such that the platform segments are used to “build out” a transfer platform 202. The transfer platform 202 likewise has bidirectional functionality to move a patient 10 from a first location 20 on one side of the transfer device 200 to a second location 30 on the other side of the transfer device 200. The transfer device 200 is conveyor-based in that the transfer platform formed of the platform segments is equipped with a conveyor belt.

FIG. 2C shows another possible transfer device 200 having a platform plate without bidirectional functionality in various implementations. The platform plate is a transfer platform 202 but can be extended out in only one direction. The transfer device 200 is conveyor-based in that the platform plate is equipped with a conveyor belt.

The transfer devices 200 of FIGS. 2A-2C may be used to perform a transfer of a patient 10 from an initial starting position on a surface, onto the device's platform, and then transfer the patient 10 off again onto the same or a different desired surface. For example, an articulated platform may be extended to a position underneath the patient 10 to be transferred—e.g. between the patient 10 and a surface on which the patient 10 is supported—and then retracted with the patient 10 supported by the transfer belt and the transfer platform so that the patient 10 is positioned above the device body. Additionally, or alternatively, a transfer platform may be extended to transfer the patient 10 positioned above the device body (i.e. supported on the transfer belt) onto to a remote surface.

While the transfer devices 200 are described specifically in relation to and in use with transferring a human body (e.g. an individual with reduced, limited, or no mobility, an able bodied individual, an unconscious individual, an incapacitated individual, etc.), it will be appreciated that the transfer devices 200 may alternatively be used to transfer other objects, such as those that may be bulky, cumbersome, delicate, and/or difficult to grasp and move. For example, the transfer devices 200 may be suited and/or adapted for use to transfer livestock or domestic animals, undomesticated animals (e.g. in a zoo or wildlife care facility), human corpses (e.g. in a funeral home of a mortuary), inanimate objects (e.g. in courier, cargo, and/or logistical operations), and the like.

Transfer devices other than those shown in FIGS. 2A-2C are possible in various implementations. Implementations of the distributed control system 100 are applicable to any suitable transfer device 200 having a transfer platform 202 capable of moving an object, regardless of whether the transfer platform supports bidirectional functionality or one-sided functionality, and regardless of whether the transfer platform is implemented using plates, segments, and/or other components. Additional examples of suitable transfer devices 200 that may be adapted for use in accordance with the present disclosure are described in International Patent Application PCT/CA2022/050044, filed 12 Jan. 2022, and published 21 Jul. 2022 as WO 2022/150915A1, titled “Devices and Methods for Transferring an Object”, which is hereby incorporated herein by reference in its entirety.

Referring back to FIG. 1, in some implementations, the system processor 110 is a Central Processing Unit (CPU), although other processors such as, but not limited to, MCUs, Field Programmable Gate Arrays (FPGAs), and Application Specific Integrated Circuits (ASICs) are possible. In some implementations, the system processor 110 includes a primary processor and a redundant processor, which can be a back-up in case there is a failure by the primary processor. In various cases the system processor 110 includes or is coupled with one or more memory devices containing instructions for configuring the system processor 110 to perform particular operations or actions. As noted elsewhere, the configuration of the system processor 110 with various instructions provides a manager system able to, among other things, monitor and communicate with the subsystem controllers 120. In some implementations, the manager system supports a human-machine interface, in addition to monitoring and communicating with the subsystem controllers 120.

According to various implementations, one or more of the subsystem controllers 120 are implemented with an MCU, although other processors including, but not limited to, CPUs, FPGAs, and ASICs are also possible. In various cases the subsystem controllers 120 also include one or more memory devices included and/or coupled with a processor. In such cases that memory stored instructions that configure the processor to carry out one or more tasks.

There are many possibilities for the various functions and/or subsystems handled by the subsystem controllers 120. Examples include, but are not limited to actuation and control of the transfer platform and belts, a Human-Machine Interface 320 (HMI) for the transfer device, lifting, tilting or other forms of positioning and location, transport of the transfer device, management and control of peripherals of the transfer device, and power delivery and management for the transfer device. Further example details are provided below with reference to the drawings. Note that additional and alternative functions are possible.

According to various implementations, the manager system can be configured to make decisions or execute pre-determined routines based on a combination of user inputs, external sensory input and/or information obtained from subsystem controllers. In such cases the manager system would automate various system and/or subsystem routines, thereby reducing demands on the operator. Automated routines could include, for example, providing the operator or user with pre-loaded transfer routines, automatically enabling a cleaning cycle, maintaining device level authorization and defensive security or performing staging and device setup routines prior to, or just after a transfer has been completed.

A potential benefit of such a manager system in various implementations would be to provide extensibility of the manager system without the need to change code on one or more subsystem controllers. For example, multiple configurations and/or transfer programs could be easily uploaded, adapted and/or adjusted by technicians and/or operators to change the configuration and behaviour of the device. This approach would greatly simplify the management and organization of coordinates, parameters and other variables associated with execution of specific sub-routines (e.g. a turning operation vs. a transfer operation) of the transfer.

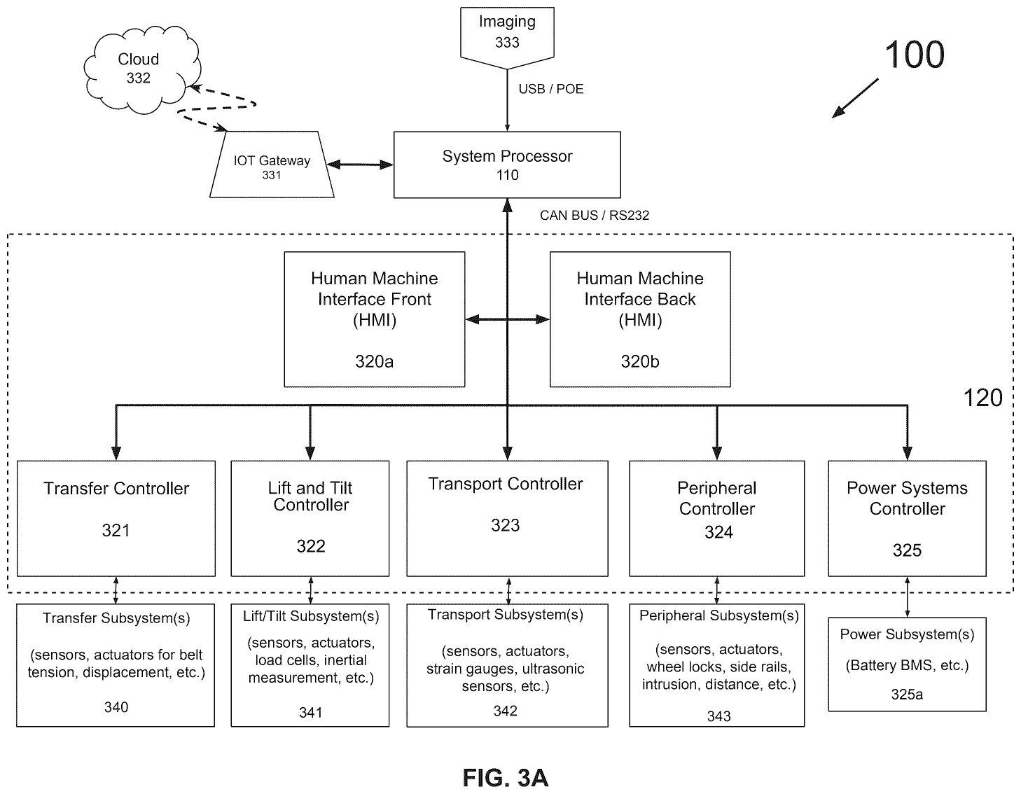

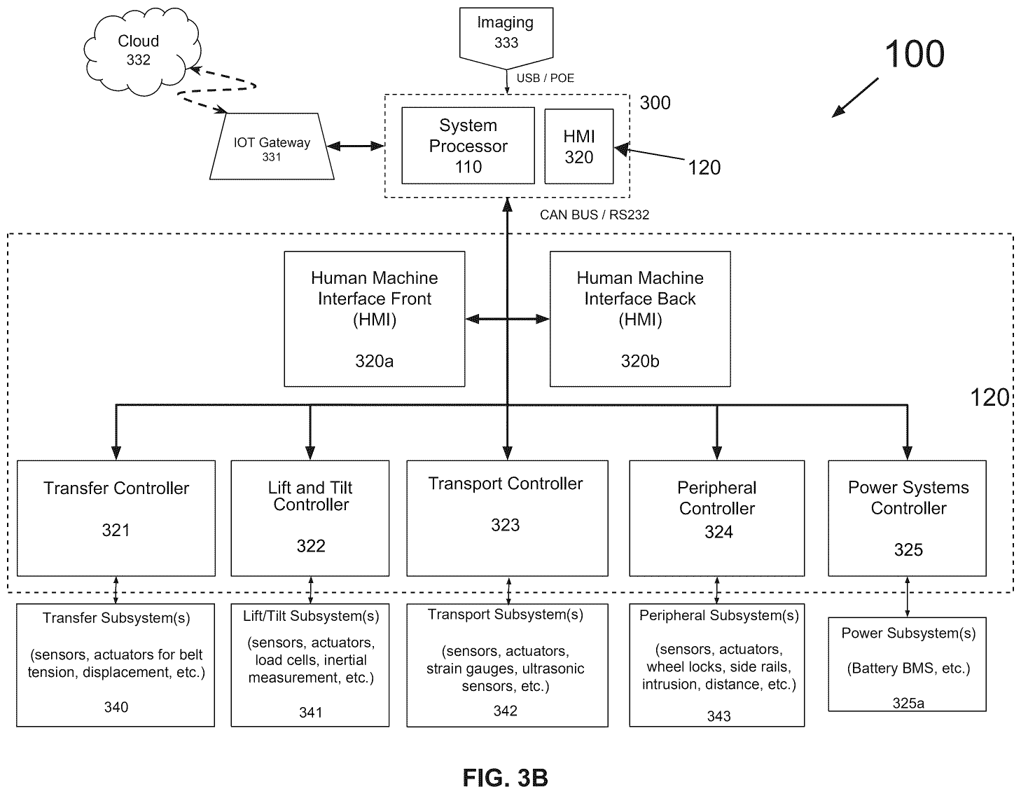

Turning now to FIGS. 3A-3B, examples of a distributed control system 100 will be described according to various implementations. The distributed control system 100 can be implemented in any appropriate transfer device, such as the examples of the transfer device 200 shown in FIGS. 2A-2C. It is to be understood that the examples of the distributed control system 100 of FIGS. 3A-3B are exemplary implementations and not intended to be limiting. Other variations of the distributed control system are possible and are within the scope of the disclosure.

In these and other implementations, the distributed control system 100 has a system processor 110 coupled to a plurality of subsystem controllers 120. The subsystem controllers 120 are configured to implement various functions of the transfer device as described in further detail below. In various implementations the system processor 110 is configured to monitor and communicate with all of the subsystem controllers 120.

As shown in FIG. 3A, in some cases the system processor 110 communicates with multiple subsystem controllers 120. The system processor 110 can be implemented by a variety of hardware, software and/or firmware in various cases. In some cases the system processor 110 is configured with instructions for carrying out one or more activities and may also be referred to as a manager system as previously noted. Subsystem controllers 120 may be implemented by a variety of computing devices (e.g., one or more processors, controllers, and/or memory devices with instructions for configuring a processor or controller) which meet the requirements of various functions of the transfer device and are further described elsewhere herein. As previously noted, the system processor 110 may communicate with a variety of subsystem controllers 120 depending on a particular implementation. An example of hardware utilized for the duties of the subsystem controllers may be Microprocessors or Microcontrollers with Reduced Instruction Set Computer (RISC) architecture. Depending on the requirements, the computers may be of various processing power, and of commonly available data bus configurations such as 8-bit through 64-bit architectures.

FIG. 3A illustrates one possible example in which the control distribution system 100 includes a system processor 110 and seven subsystem controllers 120 that interface with and control one or more operational subsystems of the transfer device. It should be appreciated that while this example illustrates seven particular subsystem controllers 120, implementations of the control distribution system 100 may have less than seven or more than seven subsystem controllers 120. Further, implementations may include some, all, or none of the specific examples shown in FIG. 3A.

In some implementations, one of the subsystem controllers 120 is a Transfer Controller 321. In various cases the Transfer Controller 321 is responsible for controlling all of the subsystems 340 that directly perform transfers of an object or patient. For example, the Transfer Controller 321 may control the movement of the transfer platform and any conveyor belts by way of external sensors and motors. In various cases user input is received by the HMI 320 and transmitted to the system processor 110. The system processor 110 (e.g. the manager system) then communicates user commands to the Transfer Controller 321. In some implementations, the system processor 110 determines optimal parameters of the transfer functions, without the requirement of specific user inputs, and communicates specific motions and state changes of the transfer platform and transfer belts to the Transfer Controller 321. The Transfer Controller 321 then controls one or more transfer subsystems 340 to bring about the motions and state changes.

As noted above, in various cases user input is received by the HMI 320. As will be discussed in further detail, in various implementations the HMI 320 may also display information to the user or operator using one or more displays or other output devices. In some implementations a transfer device 200 may have one, two, or more separate HMI devices. As an example, FIG. 3A illustrates a control system 100 that includes both a front HMI 320a and a back HMI 320b, referring to the physical locations of the HMI devices 320a, 320b at the front and back, respectively, of the transfer device 200. As another example, FIG. 3B illustrates a control system 100 that includes both the front and back HMIs 320a, 320b and also another HMI 320 integrated within a computing device 300 with the system processor 110. For convenience, references to the HMI 320 herein are also applicable to the front HMI 320a and the back HMI 320b unless otherwise stated or understood.

Although not required, in various cases one or more HMIs 320 may operate as a subsystem and/or subsystem controller. As an example, in FIG. 3A, each HMI 320a, 320b is illustrated as including a subsystem controller 120. The example in FIG. 3B shows that in some cases each HMI 320, 320a, and 320b operate as a separate subsystem controller 120. In some cases a single subsystem controller may control two or more HMIs (e.g., HMI 320a, 320b). As another example, in some cases the system processor 110 or another subsystem controller may control one or more of the HMIs 320. Other configurations are also possible depending up on a particular implementation.

Continuing with reference to FIG. 3A, in some implementations, one of the subsystem controllers 120 is a Lift and Tilt Controller 322 that interfaces and controls one or more Lift/Tilt subsystems 341. In various implementations the Lift and Tilt Controller 322 allows the user to adjust the height and angles of the transfer platform. In various cases user input is received by the HMI 320 and communicated to the Lift and Tilt Controller 322. In some implementations, the system processor 110 determines optimal heights and angles of the transfer platform, independent of user input, and communicates the heights and angles to the Lift and Tilt Controller 322. The Lift and Tilt Controller 322 then controls various actuators and sensors within one or more subsystems 341 to make the desired height and angle adjustments.

In some implementations, one of the subsystem controllers 120 is a Transport Controller 323. In various implementations the Transport Controller 323 allows the user to drive the transfer device 200 from one location or room to another using one or more Transport subsystem(s) 342 that include a driven wheel or multitude of driven wheels that accepts inputs for acceleration, steering and braking. In various cases user input is received by the HMI 320 and communicated to the Transport Controller 323 by the manager system (e.g., system processor 110). In some implementations, the system processor 110 determines the best path to transport the transfer device or intervenes on behalf of the user in order to maintain safety or automate the transportation of the transfer device through direct communication to the Transport Controller 323.

Continuing with reference to FIG. 3A, in some implementations one of the subsystem controllers 120 is a Peripheral Controller 324. According to some implementations, the Peripheral Controller 324 interfaces and controls one or more peripheral subsystem(s) 343 that include various sensors and/or actuators for controlling peripherals not involved in the actual movement of the transfer device for patient transfer.

In some implementations, one of the subsystem controllers 120 is a Power Systems Controller 325, which in some cases controls power delivery to all electronic components of the distributed control system 100 and to actuators of the transfer device 200. In addition, in various cases the Power Systems Controller 325 communicates with and provides power to the other subsystem controllers 120 and the system processor 110, as well as an imaging subsystem 333 in some cases. In some implementations it may also provide power to an Internet of Things (IOT) gateway 331. It should be appreciated that while the example refers to an IOT gateway 331, the external connection of the distributed control system 100 could also be another form of networking device such as an intranet, wireless access point or cellular modem for example.

In some implementations, the distributed control system 100 implements a Controller Area Network bus (CAN bus) network so as to allow one or more of the subsystem controllers 120 within the distributed control system 100 to communicate with each other without a host computer or complex dedicated wiring. This can make it possible for the subsystem controllers 120 to communicate directly with each other without involvement by the system processor 110. That being said, in various implementations the system processor 110 can function as a nexus or intermediary between the subsystem controllers 120. It should be appreciated that while a CAN bus network is illustrated in this example, any communication network viable for distributed computing may be utilized. Examples of possible communication networks include, but are not limited to, Recommended Standard 232 (RS232), Serial Peripheral Interface (SPI), and Transmission Control Protocol (TCP). It should also be appreciated that multiple parallel or sequential communication networks may be implemented by the subsystem controllers 120. The subsystem controllers may also have a communication network implemented internally, that does not communicate with the system processor 110.

According to various implementations, the system processor 110, the Transfer Controller 322, the Transport Controller 323, the Peripheral Controller 324, and the Power System Controller 325 collectively operate to enable basic operations and additional functionality for the transfer device 200. In some cases the basic operations can for example include height adjustment (e.g. lift up/down), angle adjustment (e.g. tilt up/down left, tilt up/down right, tilt up/down front), pick up from left, pick up from right, drop off to left and drop off to right. In some cases the additional functionality can include various features beyond the basic operations. Further details of the system processor 110, the Lift and Tilt Controller 322, the Transport Controller 323, the Peripheral Controller 324, and the Power Systems Controller 325 are provided below.

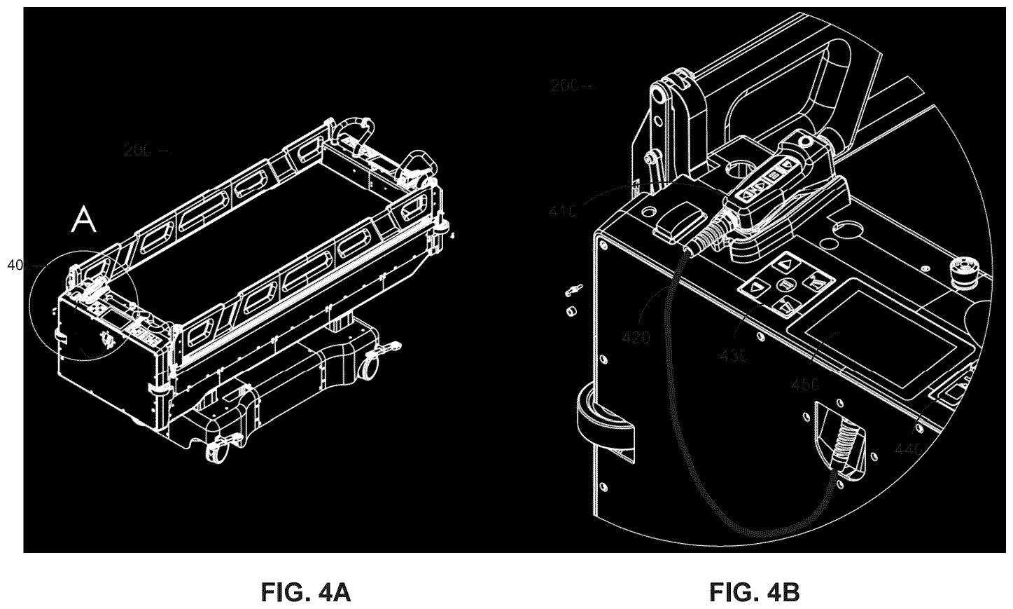

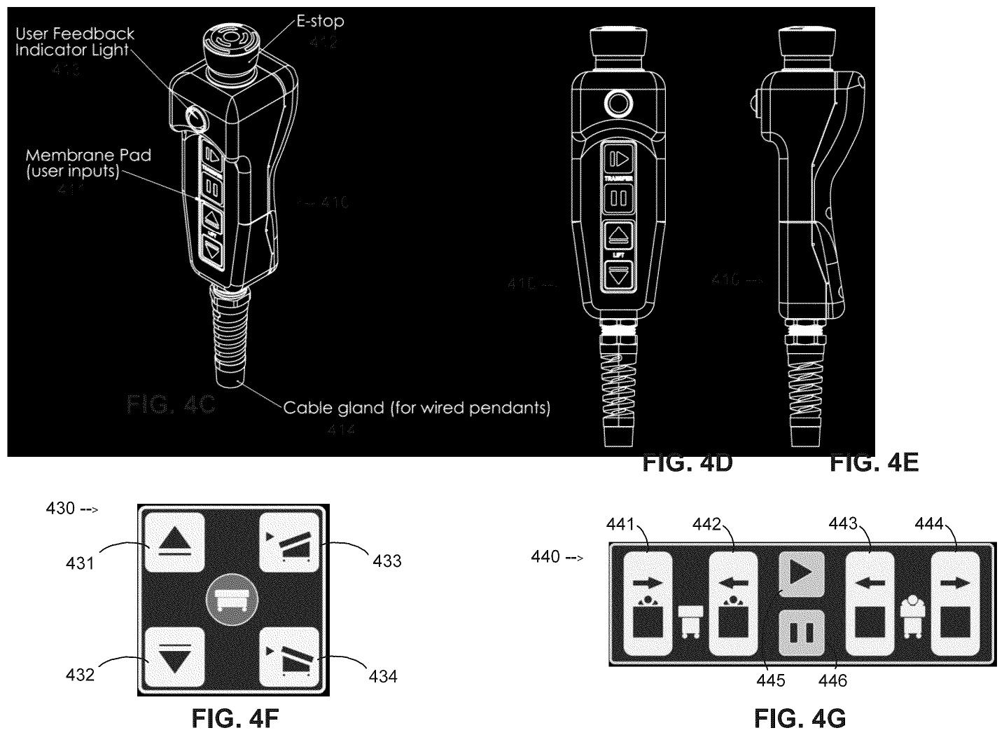

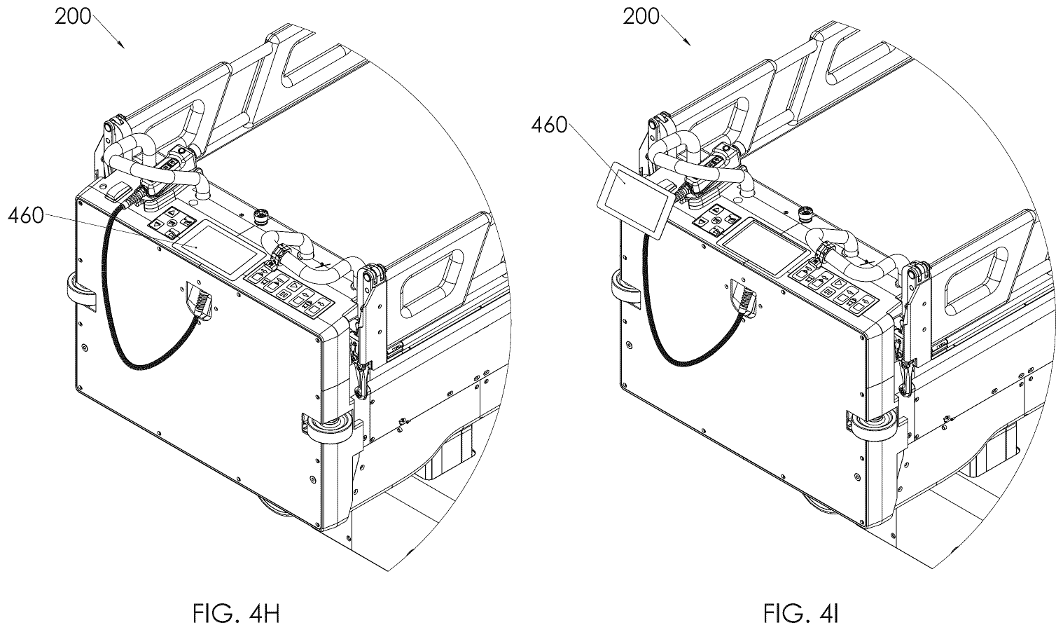

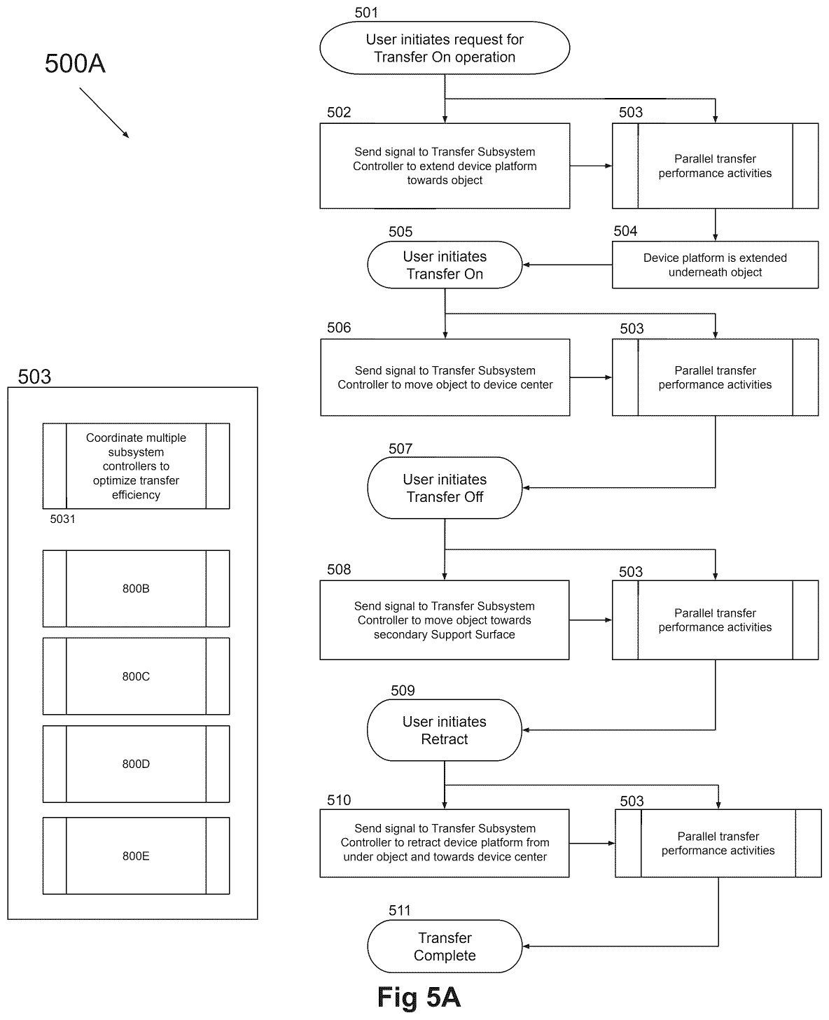

As noted above, in some implementations, the HMI 320 includes an output device that provides the user with feedback. Such feedback can include the status of the transfer device, thus allowing the user to monitor the operation of the transfer device. Although the output device would typically include a display screen, it is noted that it can additionally or alternatively include other types of output devices. Examples include, but are not limited to, an audio speaker device for conveying status by speech. Further details about user interface controls for the HMI 320 according to various implementations are provided later with reference to FIGS. 4A-4I.

In some implementations, user input is received by the HMI 320 and communicated from the system processor 110 to the Transfer Controller 321 to determine a direction of the transfer platform and how the conveyor belts are to extend for pickup and drop off. The relationship between the transfer platform and the conveyor belt determines how the patient moves. In some transfer operations, this relationship can be configured so that the patient has zero velocity relative to the velocity of the conveyor belt during pick up and drop off. Ensuring this kinematics relationship between the conveyor belt and patient minimizes the risk of any shearing movements of the conveyor belt to the patient's clothing or skin. Particularly when the transfer platform is being extended to get under the patient, and when it is being retracted for drop off, this configuration can improve the patient's comfort and overall experience. In some implementations, the transfer device is bidirectional meaning the Transfer Controller 321 is able to instruct the transfer platform to perform transfer operations onto the transfer device or off of the transfer device on both the left and right sides of the transfer device.

As noted above, in some implementations, the Transfer Controller 321 controls movement of the transfer platform and any conveyor belts by way of sensors and motors. In some implementations, this includes encoders for sensing the speed of the motors, linear displacement sensors for measuring the conveyor belt tension and positioning sensors for determining the position of the transfer platform. In some implementations, the Transfer Controller 321 is pre-programmed with pre-determined limitations or safety thresholds on transfer parameters being monitored. For example, on a transfer device 200 which has open ended conveyor belts, the transfer controller 321 may know the length of belt required to perform a single transfer, and can bias and automatically reset the transfer platform and conveyor belts to a default position in order to prepare subsequent or consecutive transfers. In some implementations, the Transfer Controller 321 receives readings from device positioning sensors to determine whether the transfer platform is home, extended or out of position.

In some implementations, the Transfer Controller 321 is configured to include several automated features that can improve overall performance of the transfer device. For example, the Transfer Controller 321 can be configured to automatically make requests to other subsystem controllers directly such as the Lift and Tilt Controller 322 and Transport Controller 323 to the directly request adjustment of the global positioning of the transfer device (e.g. vertical height, tilt angle and position within the room) based on a patient's support surface (e.g. bed, stretcher) and patient location to ensure the correct positioning prior to starting the transfer sequence. In some cases measurements from load sensors taken by other subsystem controllers 120 can be used by the Transfer Controller 321 to sense an appropriate force/interaction between the support surface and the transfer platform, thereby enabling the Transfer Controller 321 to determine the global positioning. In some implementations, these automated features are included in the system processor 110 instead of the Transfer Controller 321.

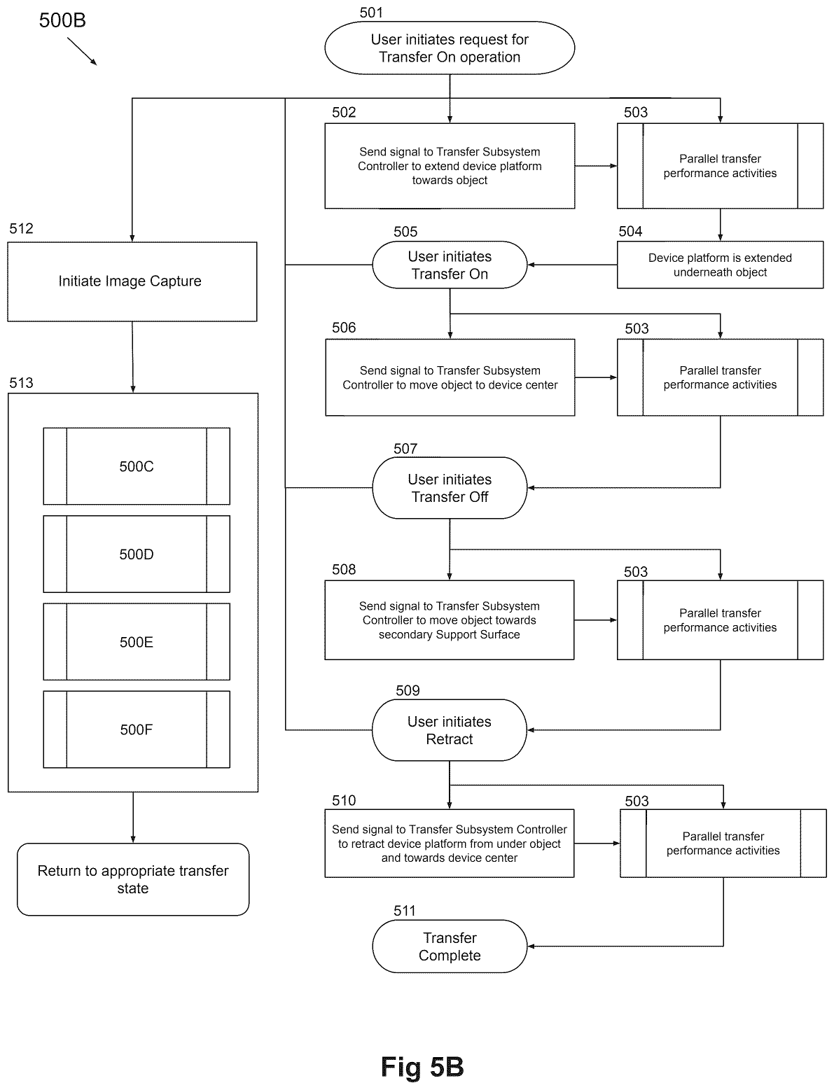

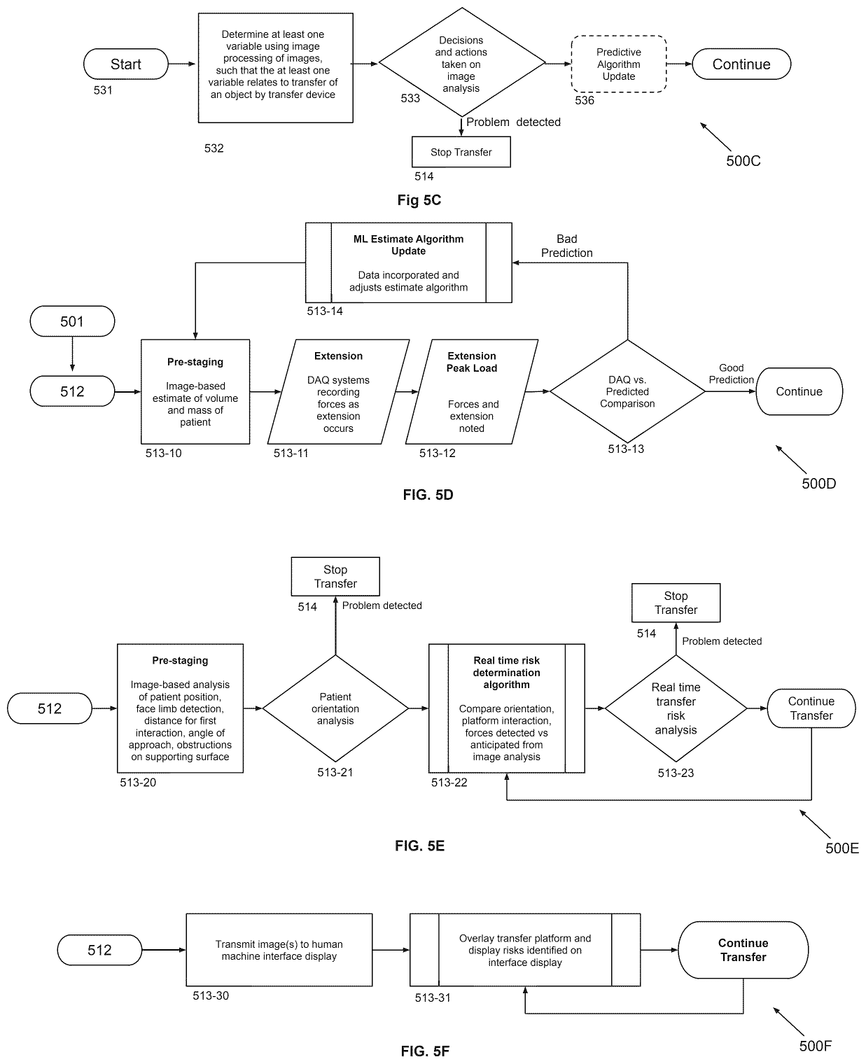

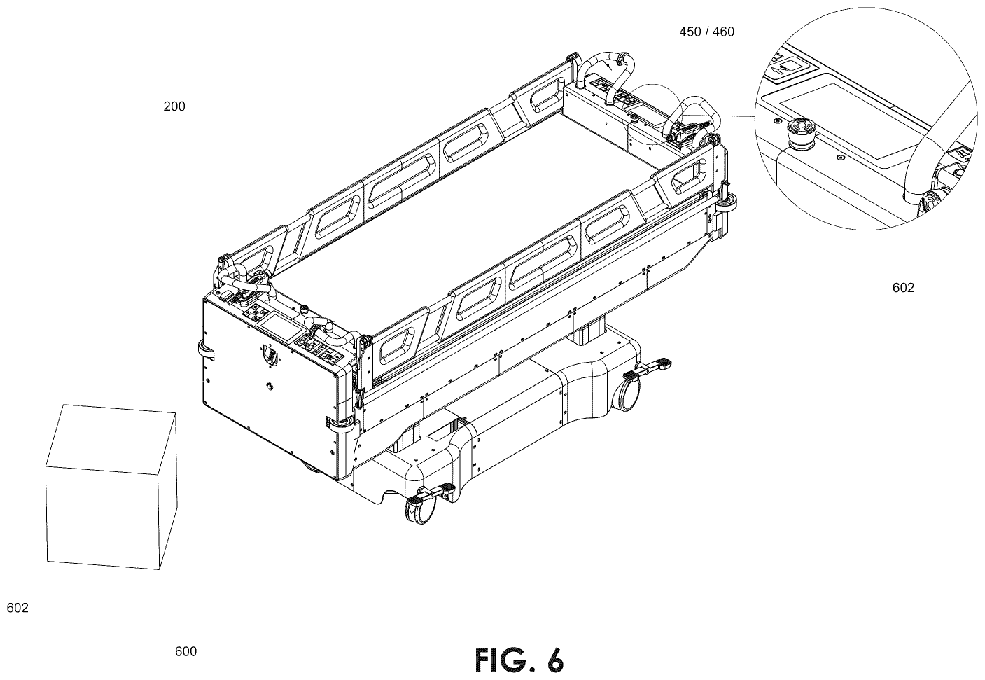

In some implementations, the Transfer Controller 321 is able to autotune device parameters and/or limits (e.g. platform speed, conveyor belt speed) based on patient size (e.g. height and weight). Implementing sensor fusion to combine all the relevant data (patient size, patient position) can enable the parameters and/or limits to be suitably determined for each patient. This can enable the transfer device to transfer any person, regardless of their size and weight. Further details of how the Transfer Controller 321 may autonomously tune and configure device parameters and/or limits are provided later with reference to FIGS. 5A and 5B.

In some implementations, in order to ensure patient safety during the transfer process, the Transfer Controller 321 implements an error handling system that can automatically abort and stop any unsafe actions. In some implementations, the Transfer Controller 321 also facilitates device assisted servicing, whereby the Transfer Controller 321 automatically repositions the transfer device or subsystems of the transfer device to allow a technician or other person to have easy access to the transfer device or subsystems of the transfer device.

As noted above, the Lift and Tilt Controller 322 allows the user to adjust height and angles of the transfer platform. In some implementations, the angles that can be adjusted include a tilt angle which enables the transfer platform to be tilted transversely so that left and right sides can be tilted up and down for example by +/−5 degrees, and a Trendelenburg angle which enables the transfer platform to be tilted longitudinally so that head and foot ends can be tilted up and down for example by +/−10 degrees. In various implementations the height, the tilt angle and the Trendelenburg angle can be altered at any point during the transfer. These alterations may be initiated automatically by the Lift and Tilt controller 322, another subsystem controller 120 or requested by the system processor 110.

In some implementations, the Lift and Tilt Controller 322 drives four linear actuators with limit switches and feedback from Hall effect sensors. If a current sensing software limit is surpassed, the Lift and Tilt Controller may decide to deactivate the linear actuators and halt transfer operation. In some implementations, thresholds for maximum tilt angle and maximum Trendelenburg angle are also defined within the Lift and Tilt Controller 322 to prevent over-tilting of the transfer platform which could be unsafe for a patient.

In some implementations, as noted above, the Transport Controller 323 controls transportation of the transfer device. In some implementations, the Transport Controller 323 implements a propulsion system, which controls motors that move the transfer device, enabling assisted transportation of the transfer device according to gestures or input commands from the user through the HMI 320. In some implementations, the Transport Controller 323 may be equipped with additional sensors and data inputs to enable automatic transportation of the transfer device 200. In such implementations, it should be appreciated by those familiar with automatic vehicle navigation that additional controllers could be integrated in order to enable technologies such as simultaneous localization and mapping or GPS (Global Positioning System) for example.

As noted above, the Peripheral Controller 324 interfaces with one or more peripheral subsystem(s) that include various different sensors for detecting and controlling things not involved in the actual movement of the transfer device for patient transfer. In some implementations, the Peripheral Controller 324 communicates with sensors for detecting patient size and position. In some implementations, sensors within the Lift/Tilt subsystem(s) 341 within the transfer device are able to measure the patient's weight, and distance sensors within the Peripheral subsystem(s) 343 such as time of flight, infrared or ultrasonic sensors are mounted on the transfer device for monitoring patient positioning during the transfer by measuring the distance between the sensor and the patient. In some implementations, the Peripheral Controller 324 can provide acquired data to the Transfer Controller 321 directly, so that the Transfer Controller 321 may customize and determine the device parameters and/or limits for each patient. It should be appreciated that this is one example of such an implementation, but that the configuration of the subsystem controllers 120 and system processor 110 are intended to be adaptable such that individual sensory inputs may be positioned throughout the transfer device in such a way as to optimize and enable the most advantageous overall configuration. Further details of how the Transfer Controller 321 may autotune device parameters and/or limits are provided with reference to FIGS. 5A and 5B.

In some implementations, the Peripheral Controller 324 provides safety features (e.g., alone, or in combination with the peripheral subsystem 343) for the distributed control system 100 to ensure patient and user safety. These safety features can include one or more of guard rail sensing, support surface proximity sensing, wheel lock sensing, patient position on the platform sensing, and service shrouding intrusion detection. According to various implementations, the guard rail sensing system detects the position of the guard rails. If the rail is up, the sensor is on, and if the rail is down, the sensor is off. In various cases the status of the sensor is communicated to the rest of the distributed control system 100. In various implementations, no transfers are allowed if the sensor is off as this means the patient side guard rail is down.

According to various implementations, the sensors for support surface proximity sensing detect the presence of a patient support surface, such as a bed, and measure the distance between the device and the support surface to ensure the device is close enough to the support surface. If there is no support surface detected or the device is too far from the support surface, for patient safety the Peripheral Controller 324 will not allow the transfer device 200 to conduct any patient transfer movements.

In some implementations, the Peripheral Controller 324 implements a wheel locking system to detect if the wheels of the transfer device are locked or unlocked, and no transfers will be allowed to occur if the wheels are not locked.

In some implementations, the Peripheral Controller 324 is connected with sensors in one or more peripheral subsystem(s) 343 for detecting the patient position and orientation when situated above the body of the transport device. The sensors can detect if the patient obstructs the side guards and if the patient is fully supported by the body of the device. The Peripheral Controller 324 communicates this sensor information to the system processor 110 which can either inform the user to take corrective action via the HMI 320 or communicate to the Transfer Controller 321 to automatically adjust the patient position within the body of the device.

In some implementations, Peripheral Controller 324 is connected with sensors in one or more peripheral subsystem(s) 343 for detecting service shrouding intrusion, such as if someone were to open up a panel or cover on the transfer device. This detection can in various cases be communicated to the Power Systems Controller 325, so that the Power Systems Controller 325 can shut off high power for actuators of the transfer device. In such cases normal applications can be disabled, and the transfer device can be serviced.

As noted above, the Power Systems Controller 325 controls power delivery to the electronic components of the distributed control system 100 and to actuators of the transfer device. In some implementations, the Power Systems Controller 325 controls power delivery to actuators of the transfer device through contactor switches which are configured to power motor drivers on and off. In some implementations, the Power Systems Controller 325 is operably in control of an electronic circuit board with individually selectable and switchable power outputs for delivering energy (e.g. 12V) to one or more of the subsystem controllers 120. In some implementations, the Power Systems Controller 325 has enough power connections to monitor all voltage and current on the power rails in the transfer device, though in some cases it may monitor less than all power levels. In some cases sensors may additionally monitor a total current in the transfer device.

In some implementations, the Power Systems Controller 325 is coupled to one or more power subsystem(s) 325a that in some cases includes a Battery Management System (BMS), which monitors and interacts with a battery to gain insight on battery status and health, such as a charge level and any errors or problems. In some cases the Power Systems Controller 325 can determine from the BMS when the battery needs to be charged and thereafter power down the transfer device 200 so that the battery can be charged.

In some implementations, there is a fan located within the transfer device 200 for cooling purposes, and the Power Systems Controller 325 controls activation of the fan. If a temperature within the transfer device 200 becomes too hot, the Power Systems Controller 325 will power on the fan to prevent overheating.

In some implementations, the transfer device 200 has two Emergency Stop (E-Stop) buttons, one on each end of the transfer device 200. In various cases an E-Stop button can be pressed to immediately stop all actions. In some implementations, the Power Systems Controller 325 has an energy dump system that monitors E-Stop status and ensures that the transfer device stops immediately when either E-Stop button has been pushed.

In some implementations, the transfer device 200 additionally has a wired or wireless remote control. The remote control (sometimes referred to as a control pendant) enables a user to walk away from the device body and closer to the object (e.g. patient) during the transfer process for monitoring and observation purposes. In such implementations, the remote control can also have an E-Stop button.

In some implementations, the Power Systems Controller 325 ensures that the transfer device 200 stops immediately upon other various triggers. For example, upon a service shrouding intrusion, the Power Systems Controller 325 can stop the transfer device. The service shrouding intrusion can be detected by sensors in one or more peripheral subsystems(s) 343, and the Peripheral Controller 324 can signal an indication of the service shrouding intrusion to the Power Systems Controller 325.

In some implementations, the Power Systems Controller 325 has a notification or alert system in order to convey messages and status reports to the operator. An example of such a system is an audio alert system like buzzer which provides audio output to alert the user to any errors or possible safety hazards. It is readily appreciated that various alert systems can be utilized, such as haptic alerts through the transfer device 200 handle bars, indicator lights or LED strips or audible vocal alerts generated by the subsystem controllers.

In some implementations, the HMI 320 can include a display screen and/or other output device for conveying information, and buttons and/or other input device for receiving user input which can be forwarded to and handled by the system processor 110.

Continuing with reference to FIG. 3A, in some implementations, the control system 100 of a transfer device 200 is connected to a communications network (e.g., internal, local, external, etc.) to provide access to various types of data. As an example, in some cases the distributed control system 100 is connected to a cloud network 332 through an IoT gateway 331. In such cases developers can receive diagnostics on performance of the transfer device, real time status of the transfer device and can upload firmware changes to the transfer device. In some cases a user can receive data about the status of a transfer, a number of completed transfers, patient information such as, for example, weight and position, and various other types of data.

As shown in FIG. 3A, in some implementations the distributed control system 100 interfaces with at least one imaging device or system 333. According to various implementations, the imaging device or system 333 may be considered to be a device subsystem of the transfer device 100 without its own imaging subsystem controller. In such cases, the system processor 110 and/or one or more other subsystem controllers may communicate with the imaging device 333. In some cases the imaging device or system 333 is considered an operational device subsystem that includes an imaging subsystem controller. In such cases imaging subsystem controller may communicate with the imaging subsystem and the system processor 110 may communicate with the imaging subsystem controller and/or the imaging subsystem itself. By incorporating imaging in the transfer device, it can be possible to allow for more precise and accurate patient positioning and further patient monitoring. In some cases the imaging device 333 can improve patient support surface proximity sensing capabilities of the transfer device, preventing or mitigating a gap between a support surface and the transfer platform of the transfer device during a transfer operation. According to various implementations, the imaging device 333 can include a radar device, a sonar or ultrasonic device, and/or a camera (standard/stereoscopic/depth) device. A combination of imaging devices is also possible, including imaging devices of varying kind. For example, the distributed control system 100 can interface with both a radar device and a camera. In some implementations, the system processor 110 learns how to estimate mass and/or volume of a patient using image processing as described below with reference to FIG. 5D

FIG. 3B is a block diagram of a distributed control system 100 similar in many respects to the control system 100 of FIG. 3A and described above. Unless otherwise indicated, the descriptions of various aspects of the control system 100 in FIG. 3A also apply to the control system 100 in FIG. 3B. As shown in FIG. 3B, in various implementations, the system processor 110 incorporates HMI 320 functionality that allows users to interact with the transfer device 200. In such an implementation, the system processor 110 can be incorporated as part of a computer 300 in order to take on additional functionality. It should be appreciated that while the HMI 320 functionality is depicted as bundled with the system processor 110 in this implementation, other subsystem controllers 120 may also be incorporated into the system processor 110 in a similar way.

Referring now to FIGS. 4A to 4I, views of example user interface controls for the HMI 320 of a transfer device 200 are illustrated according to various implementations. FIG. 4A shows an example location 402 of the user interface controls on an end of the transfer device 200. Note that the other end of the transfer device 200 may have the same user interface controls in some implementations. FIG. 4B shows a close up view of the example location 402 including example components of the user interface controls. As shown in FIG. 4B, in various implementations the user interface controls include a control pendant 410 with a cable 420, a first keypad 430, a second keypad 440, and a display screen 450. Although the control pendant 410 is wired using the cable 420, in other implementations the control pendant 410 is wireless in which case the cable 420 can be omitted. Note that the components that are depicted and their location on the transfer device 200 are for illustration only and are provided merely for exemplary purposes. Other implementations are possible.

FIGS. 4C-4E show details of the control pendant 410 according to various implementations. The control pendant 410 has a membrane pad 411 for receiving user input, an E-Stop button 412 to immediately stop all actions, an indicator light 413 for providing user feedback, and a cable gland 414 for wired implementations. FIG. 4F shows details of the first keypad 430 including an up button 431 for elevating the transfer device 200, a down button 432 for lowering the transfer device 200, a left tilt button 433 for tilting the transfer device 200 to the left, and a right tilt button 434 for tilting the transfer device 200 to the right. FIG. 4G shows details of the second keypad 440 including four buttons 441-444 for selecting a patient transfer as depicted, a play button 445 for proceeding with the transfer that has been selected, and a pause button 446 to pause the transfer. Other user interface controls are possible in addition to, or instead of, what is shown in the drawings.

FIGS. 4H and 4I show details of an HMI tablet 460 for use with a transport device 200 according to various implementations. FIG. 4H illustrates one possible implementation of the HMI tablet 460 removably mounted between the first and second keypads 430, 440 of the transfer device 200 in place of the display screen 450 illustrated in the example shown in FIGS. 4A and 4B. FIG. 4I illustrates the mounting of the HMI tablet 460 nearing a corner of the transfer device 200 according to various implementations. Of course other locations and manners of mounting the HMI tablet 460 are possible in various implementations.

In some cases, the incorporation of some or all of the functionality of the HMI 320 into an HMI Tablet 460 gives an operator increased mobility when operating the transfer device 200 without, for example, compromising the functionality of the HMI 320 by improving the ease of use compared to a traditional pendant design. In some cases a touchscreen component of the HMI Tablet 460 can be used when mounted to the transfer device 200, as well as when removed from the transfer device 200, at which point it can be used like a tablet. When mounted to the device, the HMI Tablet 460 can also be plugged into its communication and power ports. In some cases the HMI Tablet can charge its battery automatically when mounted, and may communicate with the device using physical wires. When the HMI Tablet 460 is not plugged in or mounted to the device, the HMI Tablet 460 relies on battery power, and communicates with the transfer device 200 via a wireless communication connection (e.g. Bluetooth connection).

According to various implementations, the operator will be able to change the orientation of the HMI screen for ease of use when the HMI is removed from the transfer device 200 and in “tablet mode.” In some cases a hand strap can be attached to the back of the HMI for safety and to allow a more secure grip. In some cases the HMI Tablet 460 can be used with an extension cord if it is not sufficiently charged but the operator still wants to utilize the tablet mode option. In such cases the power and communication mode can be much the same as when the HMI Tablet 460 is mounted and plugged into the transfer device 200. In some cases the accessibility and location of the HMI 320 on one or more (e.g. front and back) sides of the transfer device 200 will still apply in implementations of an HMI Tablet 460.

According to various implementations, the HMI Tablet 460 can also implement a “find my tablet” functionality. For example, in some cases the transfer device 200 includes a button located in the mounting area of the missing HMI that can be pressed if the HMI Tablet 460 is misplaced, pressing the button can send a command to the HMI Tablet 460 that will cause the device to, for example, beep and flash a light in order to aid in the location of the HMI Tablet 460.

FIGS. 5A-5F are flow diagrams illustrating various transfer device 200 routines according to various implementations. In various cases the manager system (e.g. system processor 110 configured with appropriate instructions) and/or one or more subsystem controllers 120 perform the routines or methods, at times in conjunction with various user inputs and/or other conditions. According to various implementations, the transfer routines may be enhanced for functionality, safety or ease of use by adding additional sub-routines that may run sequentially or in parallel to the transfer operation. FIGS. 5A-5F also include examples of how these transfer routines may be improved and augmented with the addition of electronic imaging to the distributed control system.

FIG. 5A is a flow diagram of a method 500A for coordinating the transfer of an object (e.g. patient) according to various implementations. At step 501 the manager system receives and processes information from the HMI 320 about the user's input regarding transfer parameters and begins the transfer process accordingly. At step 502, the manager system signals the Transfer Controller 321 to extend the device platform towards the object.

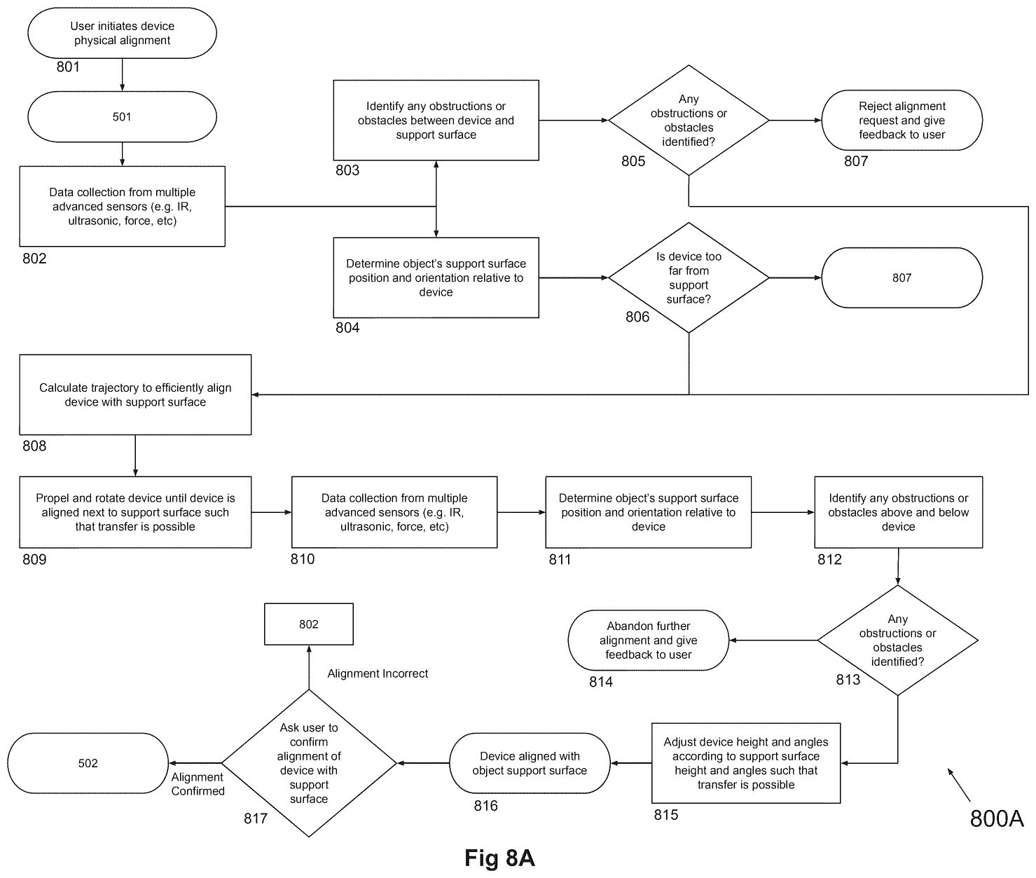

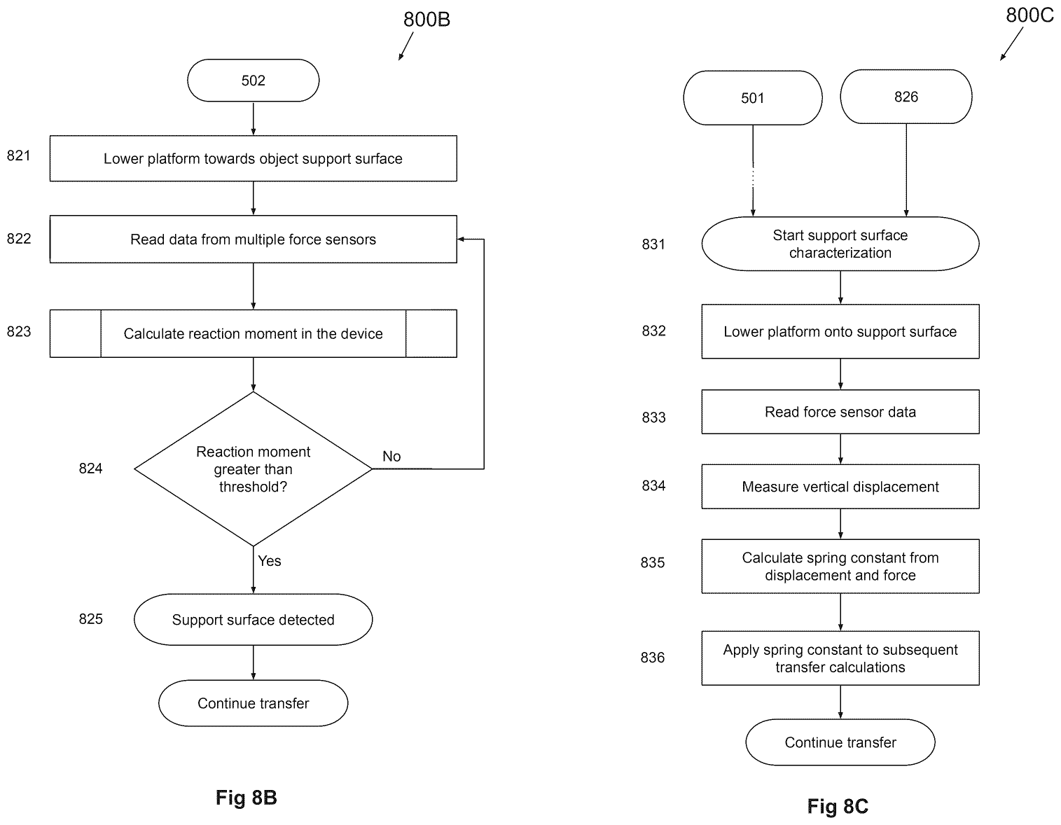

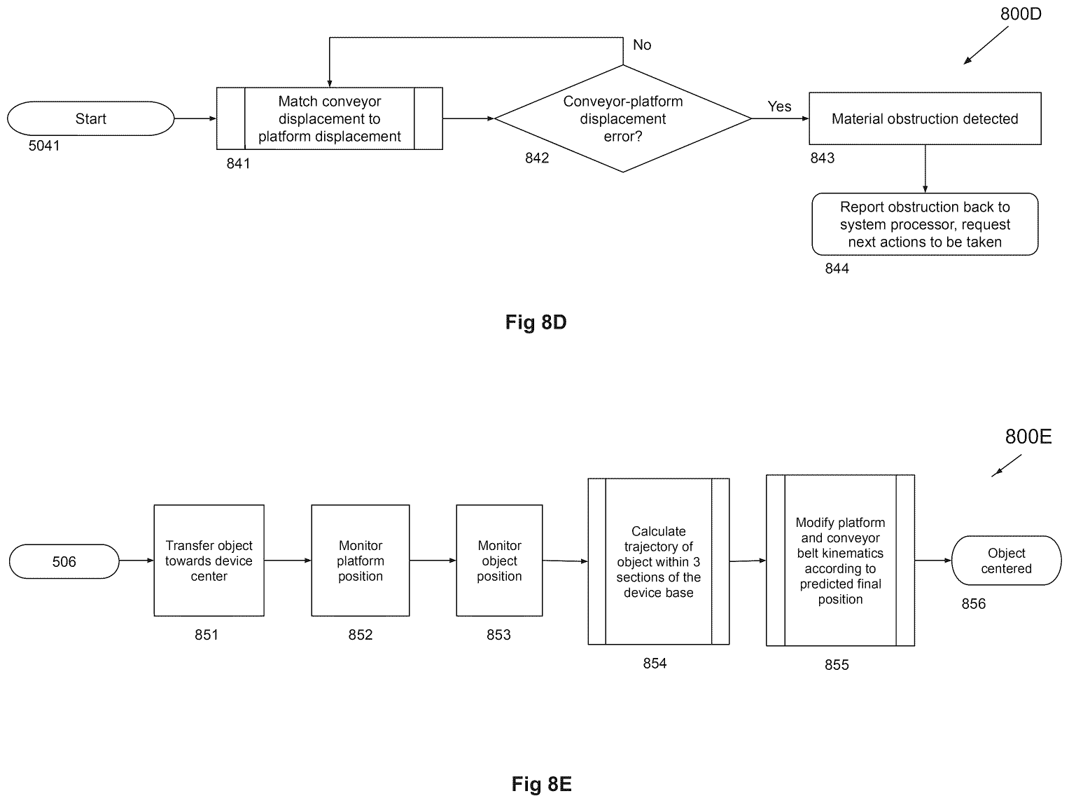

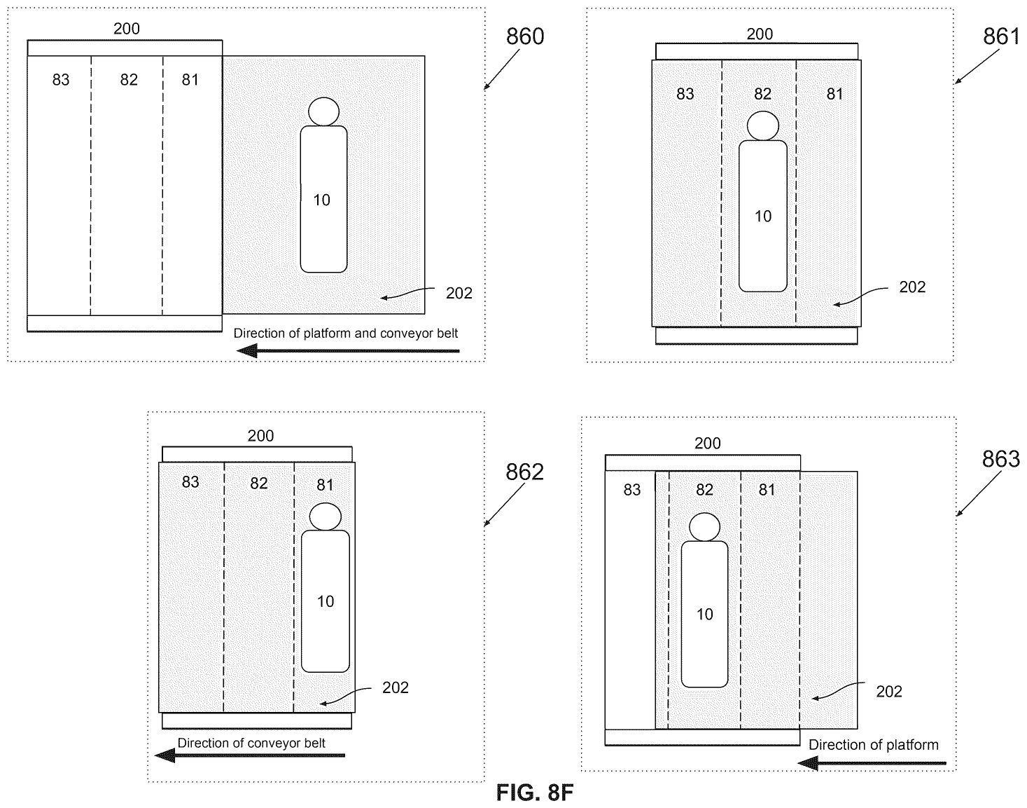

As the device platform is extending towards the object, parallel transfer performance activities 503 may be completed. For example, in some cases the manager system may coordinate multiple subsystem controllers 120 to detect a support surface underneath the object in order to efficiently complete a transfer. An example of such a surface detection method is further described in FIG. 8B. Another possible parallel activity involves the Transfer Controller 321 executing a method for detecting material obstructions as it extends the device platform. An example of such a material obstruction detection method is described further in FIG. 8D. Another possible parallel transfer performance activity 503 is the coordination of multiple subsystem controllers 120 to optimize transfer efficiency 5031, such as coordinating the Transfer Controller 321, the Lift and Tilt Controller 322, and the Peripheral Controller 324, to optimize the platform's speed and path under the object. In various implementations, the manager system monitors the parallel transfer performance activities 503 and modifies the transfer behaviour accordingly.

After extending the device platform under the object 504, the manager system coordinates with the HMI 320 to request confirmation from the user to continue the next step of transfer, described as Transfer On in step 505. If confirmation is received at step 505, the manager system signals 506 the Transfer Controller 321 to move the object towards the device. Parallel activities step 503 is initiated again in parallel with step 506. According to various implementations, the manager system coordinates multiple subsystem controllers 120 to execute a method to center the object above the device base 506 to prevent unsafe and uncomfortable conditions. An example of such a method is described further in FIG. 8E.

At step 507, the manager system waits for the HMI 320 to communicate the user's intent to transfer the object (e.g. patient) off of the device. Upon receiving the user's input regarding transfer parameters, the manager system sends a signal to the Transfer Controller 321 to move the object towards a subsequent support surface, which can be different from or the same as the support surface from which the object was initially moved. Step 503 is executed again as the Transfer Controller 321 moves the object onto the support surface.

When the Transfer Controller 321 has completed moving the object onto the support surface, the manager system waits for the HMI 320 to communicate the user's confirmation to complete the final step of the transfer process, described in step 509 as Retract. When confirmation is received, the manager system signals 510 the Transfer Controller 321 to retract the device platform from under the object and move the platform back towards the device center. Parallel transfer activities 503 are executed again while the Transfer Controller 321 moves the platform towards the device. During this process, the manager system may initiate methods such as obstruction detection 800D to monitor for any displacement or position problems due to obstructions occurring between the support surface and the device. Transfer is complete at step 511 when the platform has returned to the device center.

FIG. 5B is a flow diagram of a method 500B for coordinating the transfer of an object (e.g. patient) using image processing according to various implementations. The transfer method 500B includes several steps that are similar to the transfer method 500A illustrated in FIG. 5A and relevant descriptions of FIG. 5A also apply to various steps in the transfer method 500B. As with transfer method 500A, transfer method 500B begins with the user initiating a request for a Transfer On operation 501. The manager system can also initiate parallel performance activities 503 as previously described.

At the same time, the system processor 100 and/or subsystem controllers 120 are configured to initiate 512 the capture of images of the object transfer. The term “image” is used herein to refer to a representation of an object, a support surface, and/or other environment outside the transfer device 200 that is sensed or otherwise acquired by the transfer device 200. In addition, unless otherwise indicated, the terms “image,” “image capture,” “image data,” and “imaging” are used herein to refer to both static images and a series of sequential images forming a video.

It should be appreciated that image capture may encompass collecting many forms of electromagnetic radiation such as, but not limited to visual spectrum, infrared, as well as X-ray. In some cases image capture may involve detecting acoustic waves, such as with sonar or ultrasound. The transfer device 200 may be configured with one or more technologies for capturing images. As described with respect to FIGS. 3A-3B, in various cases the transfer device may include an imaging device 333 such as, for example, a radar device, a sonar or ultrasonic device, and/or a camera (standard/stereoscopic/depth) device. A combination of two or more imaging devices is also possible, including imaging devices of varying kind. Examples of the locations for image capture may include the device platform, the support surface, the device's surroundings (i.e. the room) and the object (e.g. patient).

Following the initiation 512 of image capture, multiple parallel processes 513 can be executed based on the acquired images. In various implementations the addition of image-based analysis can improve the safety and efficacy of the transfer process. Some examples of possible parallel processes 500C, 500D, 500E, and 500F are described with respect to FIGS. 5C-5F. For example, FIG. 5D and FIG. 5E present methods of analyzing the captured images in order to generate additional information to aid in other routines. As an example, image analysis can be used to improve the accuracy of extending the device platform 502, such as in the routine 800A for aligning the transfer device as shown in FIG. 8A. Image capture 512 can be initiated during all other transfer steps in parallel as well according to various implementations. As another example, in some cases analyzing the captured images, (e.g., according to the methods presented in FIG. 5C-5F) can provide additional data for centering 506 the object, as well as to monitor the new transfer area, detect obstructions, and prevent unsafe conditions during the transfer operation.

FIG. 5C is a flow diagram of a method 500C of performing image processing to determine at least one variable relating to transfer of an object according to various implementations. The image processing method 500C can be executed by the manager system implemented by the system processor 110 of the distributed control system 100 shown in FIG. 3. In various implementations, the manager system includes a machine learning algorithm to determine the at least one variable. According to various implementations, the method 500C of FIG. 5C can be executed by any processor of a transfer device 200, including a processor that might not be part of a distributed control system 100.

As shown in FIG. 5B, the method 500C begins following image capture 512. The processor carrying out the method receives one or more captured images from at least one imaging device. As an example, the processor may receive a sequence of images forming a video feed. Turning to FIG. 5C, at step 532, the processor determines at least one variable using image processing of the captured images, such that the at least one variable relates to transfer of an object by the transfer device.

There are many possibilities for the at least one variable. In some implementations, the at least one variable includes a mass and/or a volume of the object. In some implementations, the at least one variable includes a position and/or an orientation of the object. In some implementations, the at least one variable includes the topography of the support surface such as the dimensions of the support surface, the smoothness of the support surface or orientation and inclination of the support surface.

In some implementations, the processor assesses a risk of damage to the object based on the at least one variable that has been determined. For example, the processor might determine that there is risk to hurting a patient due to a position or orientation of the patient (e.g. patient is facing down), and hence the patent transfer could be postponed or stopped. In other control algorithm implementations, the risk of damage to the object could be based on the probability of unintended impacts or excessive force of the transfer device with the object being transferred. For example, through the use of depth cameras, the imaging system could predict the platform extension distance before it is likely to interact with the patient, thereby adjusting its extension path accordingly in terms of stroke versus height. An example of such a process will be described in further detail below with reference to FIG. 5E.

In some implementations, the captured images (e.g. video feed) could be superimposed with desired aids for the operator. Such aids could include alignment aids when driving the transfer device 200 during its transportation, alignment of the transfer device to the support surface, or alignment relative to the object being transferred. An example of such super-positioning is depicted in FIG. 6.

In some implementations, the processor (e.g. the manager system, a subsystem controller, or another processor) records the captured images (e.g. video feed) for future playback. In some implementations, the processor establishes an external data connection, and sends the images over the external data connection to an external receiving unit for monitoring and observation (e.g., by a remote operator or user, or for analysis by a remote computer system).

According to various implementations, an imaging device 333, that is a digital camera-based approach (e.g. CMOS, CCD, infrared, depth camera), or a combination of digital cameras, can be used to perform monitoring and/or surveillance of the transfer of a patient (or other object). For safety purposes, the camera 333 can determine whether the patient is in a compromised position (e.g. faced down) and should not be transferred by the transfer device 200. During the process of the transfer, the camera 333 can monitor whether the patient becomes agitated, or if the patient starts to move or roll into unsafe positions. In such cases the manager system can intervene to take appropriate actions such as stopping the transfer. This approach may also be used to act as a data record for employee monitoring or insurance auditing purposes if the captured images (e.g. video stream) are recorded during the transfer process. For example, should an accident occur (e.g. a patient is dropped or harmed), the camera footage can be replayed as evidence of what occurred during the event.

In some implementations, the processor determines parameters and/or limits for the transfer device 200 to transfer the object based on the at least one variable that has been determined. For example, the processor might determine the parameters and/or limits based on a mass and/or a volume of the object. In some implementations, the processor receives feedback regarding measured forces during transfer of the object, and adjusts the parameters and/or limits in accordance with the feedback. An example of such a method will be described in further detail below with reference to FIG. 5D.

FIG. 5D is a flow diagram of a method 500D for estimating mass and/or volume using image processing. This method can be executed by a processor, for example by the system processor 110 of the distributed control system 100 shown in FIGS. 3A-3B. In particular implementations, the manager system executed by the system processor 110 includes a machine learning algorithm to predict mass and/or volume. More generally, the method of FIG. 5D can be executed by any processor of a transfer device, including a processor that might not be part of a distributed control system.

In various implementations, prior to the beginning of a transfer sequence, the processor incorporates data obtained from sensors and cameras within various subsystems of the transfer device 200 in order to make an estimate of the mass and/or volume of the patient. After a user initiates a transfer request 501, image capture is initiated 512 and the processor performs a camera and distance sensor pre-assessment. Such a pre-assessment might include measuring the distance to the edge of the support surface or first interaction with the patient for example. At step 513-10, the processor performs an image-based estimate of volume and mass of the patient, in accordance with a configuration of an algorithm. For example, in various cases the processor estimates the weight of the object based on a count of the objects' pixels and the objects' density.

In the example of transferring a patient, the density of a human is well defined. Therefore, in various cases the processor counts the number of pixels making up the patient in the image to then determine the patient's size in pixels. The processor is configured to estimate the patient's volume based on the pixel count and calculate an estimated mass for the patient based on the estimated volume and density of the patient. In some cases the processor is configured to first convert the patient's size in pixels to real world dimensions (e.g. pixels per mm) before estimating the volume and/or subsequently calculating the mass. Accordingly, the processor (e.g., manager system) can estimate the total mass and weight distribution of the patient, and as a result of this prediction can also predict the anticipated forces on the platform and at which locations during the platform extension process these forces will be experienced. The mass and weight distribution of the patient combined with the support surface characteristics can also be used by the manager system to predict the upward forces on the platform. Such estimates are used to determine transfer parameters and/or limits for the transfer sequence.

During the transfer sequence, at step 513-11 the processor acquires data from a Data Acquisition (DAQ) system corresponding to forces acting downward (e.g. from the patient), upward (e.g. from the support surface), or in another direction upon the device platform and/or device body, as well as the device platform extension distance, which will correspond to the volume and/or mass of the patient imposing forces unto the platform during various stages of the transfer process. The data from the DAQ system can for example include sensor data measured by the Peripheral Controller 324 and/or Lift and Tilt Controller 322. At step 513-12, the processor analyzes the measured force data (e.g. from force sensors attached to the platform structure, or load cells in the base of the device) in order to determine the forces and the extension that was used to extend the platform under the patient, based on the data from step 513-11. At step 513-13, the processor compares the forces and extension distance from step 513-12 against forces and extensions that would be expected based on the image-based estimate from step 513-10.

If the processor determines that the forces and extension distance from step 513-12 are consistent with what is expected to within a defined tolerance (e.g. within +/−5%), then no changes to the configuration of the algorithm are made and the transfer sequence proceeds until it is completed. However, if the processor determines that the forces and extension from step 513-12 are not consistent with what is expected to within the defined tolerance, then at step 513-14 the processor adjusts the configuration of the algorithm as well as provides training data to the image weight estimation routine. This can enable the transfer parameters and/or limits for the transfer sequence to be adjusted in real-time for the current transfer sequences. Additionally, or alternatively, the adjustment of the configuration of the algorithm can enable improvement on subsequent transfer sequences. Adjustments to the configuration of the algorithm can include modifying platform extension forces to be expected, belt tensions, modifying pre-set platform transfer heights (e.g, for required compression into the support surface) or angles to name a few examples.

By improving the configuration of the algorithm over time, actuators of the transfer device 200 may utilize only enough force as may be appropriate given the size (e.g. volume and/or weight) of the object (e.g. patient) being transferred. This can avoid a situation in which too much force is used, which could result in the transfer being too rough or even dangerous, as well as a situation in which too little force is used, which can result in the transfer not being performed successfully. Thus, the predictive algorithm can help to improve, for example, patient comfort and satisfaction as it adjusts the transfer parameters and/or limits for each patient. Additionally, it is a safety feature as the algorithm can prevent high forces from being applied to small patients.

FIG. 5E is a flow diagram of a method 500E of assessing transfer risk using image processing according to various implementations. This method can be executed by a processor, for example by the system processor 110 of the distributed control system 100 shown in FIGS. 3A-3B. In particular implementations, the manager system executed by the system processor 110 includes a machine learning algorithm to determine the transfer risk. More generally, the method of FIG. 5E can be executed by any processor of a transfer device, including a processor that might not be part of a distributed control system.

As shown in FIG. 5E, the method 500E begins following image capture 512. In various cases a pre-staging step 513-20 involves an image-based analysis of the patient position, face and limb detection, the distance to extend the platform for first interaction, the angle of approach, and possible obstructions on the supporting surface. Facial recognition, edge and object detection, and geometric transpositions are examples of some methodologies that can be used to perform the analyses described in step 513-20. Following this analysis, a patient orientation analysis 513-21 occurs, which can include analyzing the rotation of their bodies and the direction of their faces. To achieve this, those versed in the art will recognize there are multiple image analysis algorithms that are able to identify key body anatomy (e.g. arms, elbows, head, etc.) in order to identify a transfer patient's orientation (commonly referred to as the ‘pose’ of a person in an image). In cases where the patient orientation analysis detects a problem (e.g. the transfer process is started with the patient faced down), the transfer is stopped 514.

If no problem is detected at step 513-21, the processor executes a real-time risk determination algorithm 513-22. In some cases the real-time risk determination involves comparing the patient orientation, platform interaction, and forces detected to the same parameters anticipated from image analysis. Examples might include comparing the starting orientation of the patient to the orientation and change thereof during the transfer, using the image analysis methods outlined above. Other examples might include, but are not limited to, analysis of the rate of change of the patient orientation, analysis of the patient's facial expressions in efforts to detect levels of pain or agitation, and analysis of potentially concerning behaviours such as body mechanics that are inappropriate (e.g. joints inappropriately pushed or bent incorrectly due to the transfer process).

According to various implementations, coupling these kinds of patient orientation analyses to the force and extension algorithms discussed above can generate more refined and accurate risk analyses. For example, the forces the transfer device DAQ systems experience should be lower during the ‘limb’ portion (e.g. egressing the arm) of platform extension compared to the mid-plane of the patient which should see the peak forces. Using these analyses, a real-time transfer risk analysis 513-23 can then be generated based on the predetermined risk profile that was determined as a reference for comparison. The transfer is stopped 514 upon detecting a problem (i.e. the risks are outside of the predetermined bounds). In other cases the transfer is allowed to proceed, with the method including continuing determination of the real time risk 513-22.

FIG. 5F is a flow diagram of a method 500F of relaying identified risks and other information to the user or operator of the transfer device 200. This method can be executed by various processors including, for example, the system processor 110 of the distributed control system 100 shown in FIG. 3, in coordination with the HMI 320. According to various implementations, the method begins with capturing one or more images 512 and then transmitting 513-30 the image(s) to the HMI 320 display. The method 500F further includes overlaying the transfer platform and displaying identified risks on the HMI display 513-31.

FIG. 6 is a perspective view of a transfer device 200 with an imaging system according to various implementations. The transfer device 200 includes an imaging device 333 located at one end of the transfer device 200. In some cases the imaging device 333 can be a radar device, a sonar or ultrasonic device, and/or a camera (standard/stereoscopic/depth) device. In the example shown in FIG. 6, the imaging device 333 captures images of an area 600 adjacent to the transfer device 200. In some implementations, the captured images are displayed on the HMI 320 display 450 and/or an HMI Tablet 460 for viewing by a device operator. FIG. 6 shows an example in which a captured image of an obstacle 602 is displayed on the display 450. In some cases the images are superimposed on the display 450 with desired aids for the operator. Such aids could include alignment aids when driving the transfer device 200 during its transportation, alignment of the transfer device to the support surface, or alignment relative to the object being transferred.

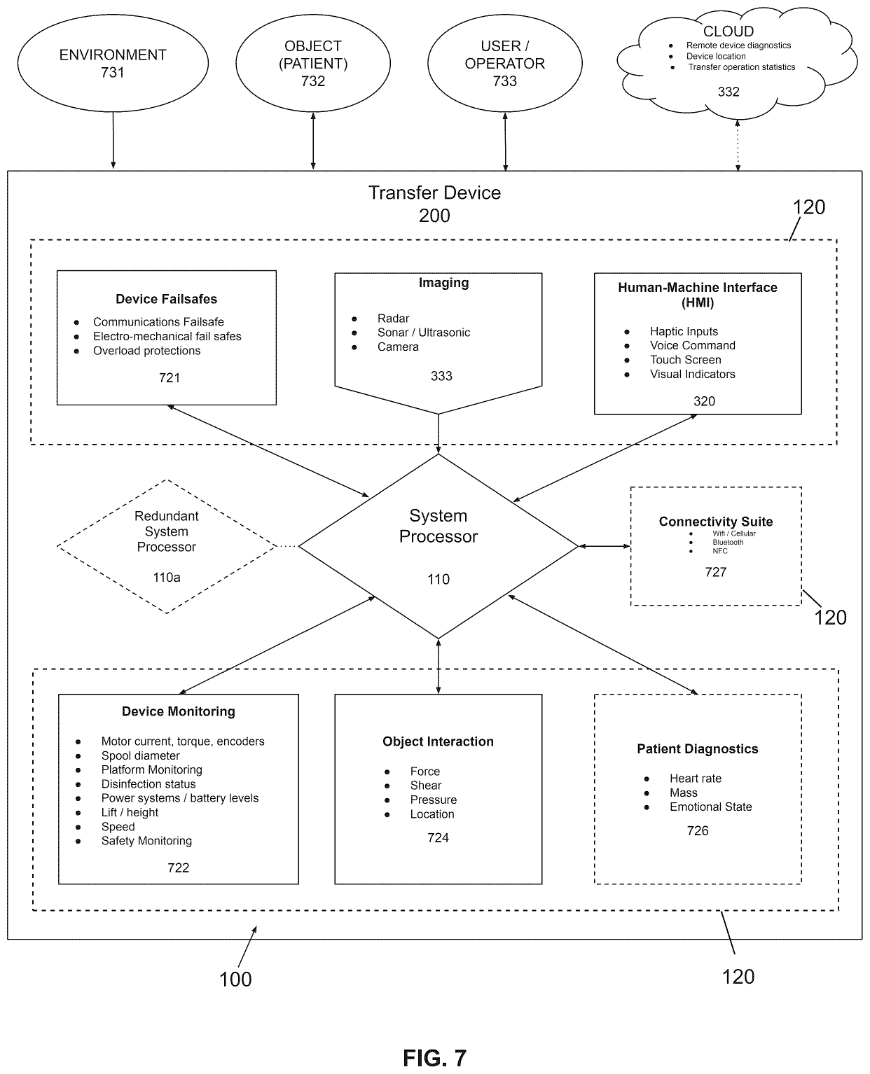

FIG. 7 is a block diagram of a distributed control system 100 for a transfer device 200 according to various implementations. The distributed control system 100 can be implemented in any appropriate transfer device, such as any of the examples of transfer devices 200 discussed herein. It should be understood that the distributed control system 100 illustrates one particular implementation and is provided merely for exemplary purposes. Other implementations of the distributed control system 100 are possible and are within the scope of the disclosure.

As shown in FIG. 7, the distributed control system 100 has a system processor 110 coupled to a plurality of subsystem controllers 120. As will be appreciated, each of the subsystem controllers 120 is configured to implement a function of the transfer device 200. Meanwhile, the system processor 110 is configured to monitor and communicate with the subsystem controllers 120. According to various implementations, the distributed control system 100 is configured to interact with, among other things, an environment 731, an object/patient 732, a user or operator 733, and a cloud network 332. In some cases the distributed control system 100 also has a redundant system processor 110a in case of failure of the system processor 110.

The functions implemented by the system processor 110 and the subsystem controllers 120 can vary among various implementations. In some cases, the distributed control system 100 can include multiple subsystem controllers with corresponding functionality as shown in FIG. 7. Some of the various functions may be similar to what has already been described above with reference to FIG. 3. In various cases, one or more of the subsystem controllers control and/or are part of one or more corresponding operational subsystems of the transfer device as discussed above. With reference to FIG. 7, in the illustrated example the system processor 110 communicates with and oversees multiple subsystem controllers including, for example, device fail safes 721, device monitoring 722, imaging 333, object interaction 724, a human-machine interface 320, patient diagnostics 726, and a connectivity suite 727. Additional and/or alternative operational subsystems and corresponding subsystem controllers 120 are also possible in various implementations.

FIGS. 8A-8E illustrate a few examples of possible routines and decisions that the manager system is configured to carry out in various implementations. Unless otherwise specified, references to one or more subsystem controllers 120 refer to the use of one or more of the subsystem controllers 120 described herein, including the examples illustrated and discussed with reference to FIGS. 3A-3B and other possible subsystem controllers 120. As an example, in some cases the manager system collects and/or receives information from various sensors via one or more subsystem controllers 120 that include, as appropriate, a Peripheral Controller 324, a Transfer Controller 321, a Lift and Tilt Controller 322, a Transport Controller 323, and/or a Power Systems Controller 325. As another example, in some cases the manager system instructs and/or coordinates with subsystem controllers to move or to stop moving part of the transfer device 200. Such subsystem controllers 120 can include, for example, the Peripheral subsystem controller 324, the Transfer Controller 321, the Lift and Tilt Controller 322, the Transport Controller 323, and/or a Power Systems Controller 325, as appropriate.

FIG. 8A is a flow diagram of a method 800A for aligning a transfer device 200 according to various implementations. The method 800A includes a subroutine or autonomous operation that the manager system could carry out to align the transfer device 200 with respect to a support surface (e.g., support surface 20, support surface 30 in FIGS. 2A-2C) according to various implementations. In steps 801 and 802 respectively, the manager system collects information from the HMI 320 to receive the user's request, and from the subsystem controllers 120 to perform analyses and determine the support surface's position and orientation 804 as well as to identify any obstructions or obstacles 803.

The manager system makes decisions 805 and 806 based on its analyses in steps 803 and 804, and can reject 807 the user's request to align the device or continue the alignment subroutine 800A. When the manager system decides to continue with the alignment 800A, it calculates the trajectory 808 across the floor to align the device and the support surface in the X and Y axes which are parallel to the floor, and commands the subsystem controllers to propel 809 the transfer device 200 accordingly. The manager system collects further information 810, 811 to identify obstacles 812 and make a decision 813 to continue or abandon the alignment subroutine 800A. When the manager system decides to continue with the alignment 800A, it commands the subsystem controllers 120 to adjust 815 the height and angles of the transfer platform 202 in the Z axis which is perpendicular to the floor, such that transfer is possible. In some implementations the manager system may further ask 817 the user or operator to confirm the alignment.

FIG. 8B is a flow diagram of a method 800B for detecting contact between the device transport platform and a support surface according to various implementations. The method 800B includes a subroutine or autonomous operation that the manager system could carry out to detect 800B contact between the transfer device 200 and a support surface. The manager system coordinates the subsystem controllers 120 to lower 821 the transfer platform and read data 822 from multiple force sensors. The manager system then calculates 823 a reaction moment for the transfer device 200. One possible method of calculating this reaction moment involves calculating the sign and magnitude of the acceleration of the forces sensed on both lateral halves of the device, where the reaction moment acts along the longitudinal centerline of the device.

At step 824, the manager system determines whether the reaction moment is greater than a prescribed threshold that is tuned to the mass, static loading and dynamic loading of the transfer device. One possible method of determining if the reaction moment meets the threshold involves confirming that the sign of the acceleration of the forces acting on the half of the device nearest to the patient is opposite to the sign of the acceleration of the forces acting on the opposite half of the device. In some implementations, an approximate threshold for the reaction moment of a transfer device that has contacted a surface is 150% to 300% of a typical reaction moment for the same transfer device that is lifting or lowering in open air. However, this value may vary depending on the mechanical configuration of a particular transfer device. Thus, in various implementations the method 800B can be used for differing device mechanical architectures by determining particular trigger thresholds corresponding to specific transfer devices.

According to various implementations, a determination that the threshold has not been met causes the manager system to return to reading data 822 and calculating 823 reaction moments until the threshold is met or the method is otherwise aborted. When the manager system determines that the reaction moment is greater than the threshold, the manager system makes a further determination 825 that the support surface has been detected. In such cases the overall transfer process is then continued. In some cases the transfer process is continued at step 826 by subsequently determining one or more characteristics of the support surface. In some cases, the manager system can search for multiple reaction moments that subsequently change directions in order to detect multiple contacts points of increasing support.

FIG. 8C is a flow diagram of a method 800C for determining characteristics of a support surface (e.g., support surface 20, support surface 30 in FIGS. 2A-2C) according to various implementations. The method 800C includes a subroutine or autonomous operation that the manager system could carry out to determine 800C characteristics of the support surface. As an example, in some cases the manager system may determine characteristics that include the width and type of mattress (e.g. air or foam mattress). The method 800C includes the manager system coordinating various subsystem controllers 120 at step 832 to lower the device transfer platform onto the support surface. The manager system also collects information from various subsystem controllers 120, including collecting force sensor data 833 and a vertical displacement 834. In some cases the manager system calculates 835 a spring constant from the collected data and then applies the spring constant to subsequent transfer calculations 836 to inform force analyses that should be exerted during the transfer process, the required displacements in order to achieve desired compression set points and determine the expected force vs. displacement profiles depending on the support surface variations. This can be useful in situations where support surfaces between patient transfers are changing dramatically (e.g. air mattress vs. foam). Overall this process can provide the advantage of optimizing workflows by not requiring the user to input the support surface type in order to adjust the transfer algorithm and optimize transfer efficiency as well as comfort for the patient.

FIG. 8D is a flow diagram of a method 800D for detecting an obstruction according to various implementations. The method 800D includes a subroutine or autonomous operation that the manager system could carry out to detect 800D a material obstruction during a transfer. According to various implementations, the manager system coordinates with a Transfer Subsystem Controller 321 to match the conveyor belt's displacement to the transfer platform's displacement, according to the kinematic requirements of each stage of the transfer process. As an example, in some cases the Transfer Controller 321 is configured to displace the conveyor belt by the same amount as the transfer platform's displacement during stages that require the object (e.g. patient) to be moved at the same displacement as the platform. Some examples include when the object is being moved onto the transfer device 100, after having the platform inserted underneath them, and when the patient needs to be moved back overtop of the support surface they will be deposited onto. In another example, the Transfer Controller 321 is sometimes configured to displace the conveyor belt by twice the amount of the transfer platform's displacement, for example during transfer stages involving the platform moving under a patient, or removing itself from beneath a patient (i.e. picking the patient up from a support surface, or returning the patient to a support surface).

After determining the actual belt displacement, the manager system then determines 842 whether there is a displacement error. In some cases determining the presence of a displacement error includes determining the difference between the expected conveyor belt displacement and the actual conveyor belt displacement. In some cases a threshold is applied to the displacement difference, with an error resulting when the difference exceeds the threshold. According to various implementations, the threshold is selected based on the sensitivity requirements of the current stage of transfer. For example, when transferring a patient unto the device, the patient should not move significantly such that they risk falling off of the transfer device. In some cases, based on control limitations, and as general guidance, belt positioning relative to the platform may be between 1 mm and 5 cm, for example, to be considered safe. In other instances, to limit any shear forces due to relative velocity mismatches between the patient and the transfer process (e.g. the platform inserting underneath the patient) the belt must not ‘drift’ more than a range of approximately 1 mm to 10 mm in order to ensure the patient does not experience any pushing sensations. In some cases determining 842 that no error is present causes the manager system to coordinate with the Transfer Controller 321 to continue controlling the conveyor belt and platform. In some cases the manager system determines 842 that there is a displacement error. In such cases the manager system can conclude 843 that a material obstruction has occurred and in some cases report the obstruction and/or request instructions for a next action to be taken 844. In some implementations, subroutine 800D can be executed by the Transfer Controller 321.

FIG. 8E is a flow diagram of a method 800E for adjusting the position of an object on the transfer device according to various implementations. The method 800E includes a subroutine or autonomous operation that the manager system could carry out to adjust 800E the location of an object such as, for example, a patient without the requirement for an imaging device such as a camera. At step 851 the manager system coordinates the subsystem controllers 120 to transfer the object towards the center of the transfer device. At steps 852 and 853, the manager system collects multiple sensors' data from the subsystem controllers 120 to monitor and compare the platform position and the object position, respectively. At step 854 the manager system uses the information from steps 852 and 853 to calculate the trajectory of the object and predict the object's final position within three sections of the device.

At step 855 the manager system coordinates the subsystem controllers 120 to modify the transfer platform and conveyor belt kinematics according to the predicted final position from step 854. For example, assuming the patient 10 position begins anywhere in the platform 202 as shown in step 860 of FIG. 8F, if the predicted final position is in the middle section 82 of the transfer device 200 as shown in step 861 of FIG. 8F, the transfer process continues to move the patient 10 to center with the platform 202 without interruption. As another example, if the predicted final position is in the first section 81 of the transfer device 200 closest to the original patient 10 location, as shown in step 862 of FIG. 8F, the manager system signals the Transfer Controller 321 to continue moving the platform to the center of the transfer device 200 and to also move the conveyor belt to adjust the patient's position to the center of the platform 202 and transfer device 200, thus moving the patient 10 away from the device edge. As another example, if the predicted final position is in the third section 83 of the transfer device 202 farthest from the original patient 10 location, the manager system signals the Transfer Controller 321 to execute zero-relative velocity relative to the transfer device 200 and thus maintain the position of the patient 10 at the center of the device while moving the platform to the center below the object as shown in step 863 of FIG. 8F, preventing the patient 10 from moving too close to the transfer device 200 edge. In some implementations, the manager system can also signal the Lift and Tilt Controller 322 to adjust the height and angle of the transfer device 200 to aid in adjusting the angle of approach and compression on the supporting surface in order to minimize elevation changes for the patient 10 and any blunt-force impacts. This, in turn will improve the efficiency, comfort and reduce potential for obstructions caused during the transfer process.

According to various implementations, a transfer device 200 and/or a distributed control system 100 can include one or more of the following aspects and features.

In some implementations, a distributed control system 100 can remove variations in user interaction and interpretation with logical data inputs and decision making capabilities, enabling a transfer device to easily and automatically accomplish patient transfers.

In some implementations, a distributed control system 100 enables automatic and semi-autonomous operation. A transfer device 200 can be controlled by the various control subsystems working together to perform patient transfers without the need for user intervention.

In some implementations, a distributed control system 100 enables ease of use. A simple and efficient user interface can allow an operator to easily adjust the transfer platform and perform patient transfers.

In some implementations, a distributed control system 100 enables basic operations including height adjustment (lift up/down), angle adjustment (tilt up/down left, tilt up/down right, tilt up/down front), pick up from left, pick up from right, drop off to left and drop off to right.

In some implementations, a distributed control system 100 enables safety and reliability. For example, in some cases the distributed control system can automatically stop any unsafe actions or transfers that could potentially harm the patient or the user, and will not begin the transfer process if the patient or the transfer device are not in a proper position.

In some implementations, a distributed control system 100 enables a high system up time (i.e. it doesn't break down frequently). In the event of a fault or failure within the control system, the patient isn't harmed and the entire system doesn't go down.

In some implementations, a distributed control system 100 enables adaptability, such that patient transfer of any patient is possible, regardless of their size (i.e. weight and/or height). The patient can be picked up from and dropped off onto any patient support surface (e.g. bed, stretcher) regardless of the height, stiffness or surface material.

In some implementations, a distributed control system 100 enables fault monitoring and redundancy. By utilizing multiple MCUs, the system has built-in fault tolerance. If a single MCU fails, the overall system has the ability to monitor communications and determine if a single controller has failed, or if the entire system is down. Also, by distributing the processing and decision making of the system, it can reduce the probability of errors in each subsystem by making firmware more manageable and subsystems unit testing more efficient than everything being managed by one core MCU.

Numerous modifications and variations of the present disclosure are possible in light of the above teachings. It is therefore to be understood that within the scope of the appended claims, the disclosure may be practised otherwise than as specifically described herein.

We claim:

1. A transfer device comprising:
a device body;
a transfer platform supported by the device body, the transfer platform comprising at least one conveyor belt configured to move an object onto and/or off of the transfer platform;
a plurality of subsystems, each subsystem configured to implement a function of the transfer device;
a plurality of subsystem controllers, each subsystem controller configured to control operation of one of the plurality of subsystems; and
a system processor in communication with the plurality of subsystem controllers, the system processor configured to:
monitor and communicate with the plurality of subsystem controllers;
receive operator inputs from a transfer device operator;
make decisions about a transfer operation based on inputs received from a transfer device operator and inputs received from the plurality of subsystem controllers; and
send commands to the plurality of subsystem controllers.

2. The transfer device of claim 1, wherein the two or more of the plurality of subsystem controllers are located in different regions of the transfer device near to one or more sensors and/or actuators.

3. The transfer device of claim 1 or claim 2, wherein the system processor and the plurality of subsystem controllers are configured to operate together to perform patient transfers automatically without user intervention.

4. The transfer device of any one of claims 1 to 3, wherein the system processor is configured to control a Human-Machine Interface (HMI) of the transfer device.

5. The transfer device of any one of claims 1 to 4, wherein the plurality of subsystem controllers comprise a subsystem controller configured to control transfers of an object.

6. The transfer device of claim 5, wherein the distributed control system is configured to receive a tension and displacement of at least one conveyor belt along with a location and speed of the transfer platform for use in methods to transfer a patient.

7. The transfer device of any one of claims 1 to 6, wherein the plurality of subsystem controllers comprises a subsystem controller configured to adjust height and angles of the transfer platform, and/or transportation of the transfer device.

8. The transfer device of any one of claims 1 to 7, wherein the plurality of subsystem controllers comprises a subsystem controller configured to control one or more peripheral subsystems of the transfer device not involved in movement of the transfer platform.

9. The transfer device of any one of claims 1 to 8, wherein the plurality of subsystem controllers comprises a subsystem controller configured to control power delivery to electronic components of the distributed control system and to actuators of the transfer device.

10. The transfer device of any one of claims 1 to 9, wherein the plurality of subsystems are configured to implement one or more of (i) transferring an object, (ii) adjusting height and angles of the transfer platform, and/or transporting the transfer device, (iii) controlling peripherals of the transfer device not involved in movement of the transfer platform, (iv) providing device security, and (v) controlling power delivery to electronic components of the distributed control system and to actuators of the transfer device.

11. The transfer device of any one of claims 1 to 10, wherein the system processor is configured to establish a secure connection to an external network to upload captured images, diagnostics data and/or download firmware changes.

12. The transfer device of claim 11, wherein the external network is an intranet configured to aid communication of multiple transfer devices to each other.

13. The transfer device of claim 11, wherein the external network is the world wide web.

14. The transfer device of any one of claims 1 to 13, wherein the system processor is in communication with an imaging subsystem comprising at least one imaging device and wherein the system processor is configured to receive at least one captured image from the at least one imaging device, and determine at least one variable using image processing of the captured image, such that the at least one variable relates to transfer of an object by the transfer device.

15. The transfer device of claim 14, wherein the system processor is configured to receive a plurality of a captured images forming a video feed from the at least one imaging device, and determine at least one variable using image processing of the video feed, such that the at least one variable relates to transfer of an object by the transfer device.

16. The transfer device of any one of claims 14 or claim 15, wherein the subsystem controllers are configured to determine at least one variable using processing of the at least one captured image, such that the at least one variable relates to transfer of an object by the transfer device.

17. The transfer device of claim 16, wherein the at least one variable comprises a mass and/or a volume of the object.

18. The transfer device of claim 16 or claim 17, wherein the at least one variable comprises a position and/or an orientation of the object.

19. The transfer device of any one of claims 16 to 18, wherein the system processor is configured to assess a risk of damage to the object based on the at least one variable.

20. The transfer device of any one of claims 16 to 19, wherein the system processor is configured to determine parameters and/or limits for the transfer device to transfer the object based on the at least one variable.

21. The transfer device of claim 20, wherein the system processor receives feedback from at least one of the subsystem controllers regarding measured forces during transfer of the object, and the system processor is configured to adjust the parameters and/or limits in accordance with the feedback.

22. The transfer device of any one of claims 16 to 21, wherein the system processor is connected to persistent memory configured to record the video or image feed for future playback.

23. The transfer device of any one of claims 16 to 21, wherein the system processor is configured to establish an external data connection and is configured to send the image or video feed over the external data connection to an external receiving unit for monitoring and observation.

24. A method for execution by a system processor of a transfer device, the transfer device comprising a device body and a transfer platform configured to move an object, the method comprising:
receiving at least one image from at least one imaging device;
determining at least one variable using image processing of the at least one image, such that the at least one variable relates to transfer of an object by the transfer device.

25. The method of claim 24, wherein the at least one variable comprises a mass and/or a volume of the object.

26. The method of claim 24 or claim 25, wherein the at least one variable comprises a position and/or an orientation of the object.

27. The method of any one of claims 24 to 26, further comprising:
assessing a risk of damage to the object based on the at least one variable that has been determined.

28. The method of any one of claims 24 to 27, further comprising:
determining parameters and/or limits for the transfer device to transfer the object based on the at least one variable that has been determined.

29. The method of claim 28, further comprising:
receiving feedback regarding measured forces during transfer of the object; and
adjusting the parameters and/or limits in accordance with the feedback.

30. The method of any one of claims 24 to 29, further comprising:
recording the at least one image for future playback.

31. The method of any one of claims 24 to 30, further comprising:
establishing an external data connection; and
sending the at least one image over the external data connection to an external receiving unit for monitoring and observation.

32. A non-transitory computer readable medium having recorded thereon statements and instructions that, when executed by a system processor of a transfer device, configure the system processor to implement the method of any one of claims 24 to 31.

33. An apparatus comprising a component or any combination of components as described and/or depicted herein.

34. A method comprising a step or any combination of steps as described and/or depicted herein.

35. A non-transitory computer readable medium having recorded thereon statements and instructions that, when executed by a processor of an apparatus, configure the processor to implement a method comprising a step or any combination of steps as described and/or depicted herein.
